(19) United States
(12) Patent Application Publication
(10) Pub. No.: US 2026/0088230 A1
(43) Pub. Date: Mar. 26, 2026

(54) ELECTRONIC COMPONENT

(71) Applicant: TDK CORPORATION, Tokyo (JP)

(72) Inventors: Yugo KANAMOTO, Tokyo (JP); Shunsuke SATO, Tokyo (JP); Ken MORITA, Tokyo (JP); Yasuhiro OKUI, Tokyo (JP)

(73) Assignee: TDK CORPORATION, Tokyo (JP)

(21) Appl. No.: 19/327,600

(22) Filed: Sep. 12, 2025

(30) Foreign Application Priority Data
Sep. 26, 2024 (JP) 2024-167005

(51) Int. Cl. H01G 4/30; H01G 4/012; H01G 4/232

(52) U.S. Cl. CPC H01G 4/30; H01G 4/012; H01G 4/232

(57) ABSTRACT

An internal electrode includes a main electrode portion and a connection portion connecting the main electrode portion and an external electrode. The connection portion is narrower than the main electrode portion in a first direction and is exposed at a partial region of an end surface positioned closer to a first main surface. A sintered metal layer includes a first portion and a second portion. The first portion covers the partial region of the end surface and is connected to the connection portion. The second portion covers at least a partial region of the end surface positioned closer to a second main surface than the partial region. A conductive resin layer includes an end-surface-side portion positioned on the end surface to cover the first portion and expose the second portion. A plating layer covers the second portion and the end-surface-side portion.

### CROSS-REFERENCE TO RELATED APPLICATIONS

This application is based upon and claims the benefit of priority from Japanese Patent Application No. 2024-167005, filed on Sep. 26, 2024, the entire contents of which are incorporated herein by reference.

### BACKGROUND

### Field

The present disclosure relates to an electronic component.

### Description of the Related Art

Known electronic components include an element body, a plurality of external electrodes disposed on the element body, and a plurality of internal electrodes disposed in the element body (see, for example, Japanese Unexamined Patent Publication No. 2003-243249). Each of the plurality of external electrodes includes a sintered metal layer and a plating layer. Each of the plurality of internal electrodes is connected to a corresponding external electrode of the plurality of external electrodes.

### SUMMARY

In a configuration in which the external electrode includes the plating layer, hydrogen may be generated when forming the plating layer. If the generated hydrogen reaches the internal electrode through the sintered metal layer, the characteristics of the electronic component may deteriorate. For example, the insulation resistance may decrease.

An object of one aspect of the present disclosure is to provide an electronic component that suppresses deterioration in characteristics.

An electronic component according to one aspect of the present disclosure includes an element body, a plurality of external electrodes, and a plurality of internal electrodes. The element body has a rectangular parallelepiped shape, and includes a first main surface and a second main surface opposing each other in a first direction, a pair of end surfaces opposing each other in a second direction, and a pair of side surface opposing each other in a third direction. The plurality of external electrodes are disposed on both ends of the element body in the second direction, and each include a sintered metal layer, a conductive resin layer, and a plating layer. The plurality of internal electrodes are disposed in the element body to oppose each other in the third direction, and are each electrically connected to a corresponding external electrode of the plurality of external electrodes. Each of the plurality of internal electrodes includes a main electrode portion opposing an internal electrode, of the plurality of internal electrodes, that is adjacent in the third direction, and a connection portion narrower than the main electrode portion in the first direction and connecting the main electrode portion and the corresponding external electrode, the connection portion being exposed at a partial region, of the end surface, that is positioned closer to the first main surface. The sintered metal layer includes a first portion covering the partial region of the end surface and connected to the connection portion, and a second portion covering at least a partial region, of the end surface, that is positioned closer to the second main surface than the partial region. The conductive resin layer includes one end-surface-side portion positioned on the end surface to cover the first portion and expose the second portion. The plating layer covers the second portion and the one end-surface-side portion.

In the one aspect, the connection portion of the internal electrode is exposed at the partial region of the end surface. The partial region of the end surface is covered with the first portion of the sintered metal layer, and the first portion of the sintered metal layer and the connection portion of the internal electrode are connected to each other.

The external electrode includes the conductive resin layer. The conductive resin layer includes the one end-surface-side portion. The one end-surface-side portion is positioned on the end surface to cover the first portion of the sintered metal layer. The conductive resin layer generally includes a plurality of electrically conductive particles and a resin. The resin included in the one end-surface-side portion impedes hydrogen from migrating from the plating layer toward the first portion of the sintered metal layer. Therefore, hydrogen tends not to migrate to the first portion of the sintered metal layer and not to reach the internal electrode. Consequently, the one aspect suppresses the deterioration of characteristics.

As described above, the conductive resin layer generally includes the resin. The conductive resin layer has an electric resistance larger than an electric resistance of the sintered metal layer that does not include the resin. An electronic component in which the external electrode includes the conductive resin layer may increase ESR (equivalent series resistance).

The plating layer covers the second portion of the sintered metal layer. The second portion of the sintered metal layer is connected to the plating layer without the conductive resin layer being interposed. Therefore, in the one aspect, the external electrode includes an electric current path not including the conductive resin layer. Consequently, the one aspect suppresses an increase in the ESR.

In the one aspect, the sintered metal layer may entirely cover the end surface.

In a configuration in which the sintered metal layer entirely covers the end surface, the sintered metal layer protects the end surface.

In the one aspect, each of the plurality of internal electrodes may include an other connection portion narrower than the main electrode portion in the first direction and connecting the main electrode portion and the corresponding external electrode, the other connection portion being exposed at an other partial region, of the end surface, that is positioned closer to the second main surface. The sintered metal layer may include a third portion covering the other partial region of the end surface and connected to the other connection portion, and a fourth portion covering at least a partial region, of the end surface, that is positioned closer to the first main surface than the other partial region. The conductive resin layer may include an other end-surface-side portion positioned on the end surface to cover the third portion and expose the fourth portion. The plating layer may cover the fourth portion and the other end-surface-side portion.

In a configuration in which each of the plurality of internal electrodes includes the other connection portion, the sintered metal layer includes the third portion and fourth portion, the conductive resin layer includes the other end-surface-side portion, and the plating layer covers the fourth portion and the other end-surface-side portion, the other connection portion of the internal electrode is exposed at the other partial region of the end surface, the other partial region of the end surface is covered with the third portion of the sintered metal layer, and the third portion of the sintered metal layer and the other connection portion of the internal electrode are connected to each other.

In this configuration, the other end-surface-side portion is positioned on the end surface to cover the third portion of the sintered metal layer. The resin included in the other end-surface-side portion impedes hydrogen from migrating from the plating layer toward the third portion of the sintered metal layer. Therefore, hydrogen tends not to migrate to the third portion of the sintered metal layer and not to reach the internal electrode. Consequently, this configuration further suppresses the deterioration of characteristics.

In this configuration, the plating layer covers the fourth portion of the sintered metal layer. The fourth portion of the sintered metal layer is connected to the plating layer without the conductive resin layer being interposed. Therefore, in this configuration, the external electrode includes an electric current path not including the conductive resin layer. Consequently, this configuration further suppresses an increase in the ESR.

In the one aspect, the second portion and the fourth portion may be continuous with each other. The end surface may be entirely covered with the external electrode.

In the one aspect, the second portion and the fourth portion may be separated from each other. The end surface may be exposed from the external electrode between the second portion and the fourth portion.

In the one aspect, the conductive resin layer may include a first-main-surface-side portion continuous to the one end-surface-side portion and covering a part of the first main surface. The main electrode portion may include a first edge opposing, in the first direction, a region of the first main surface covered with the first-main-surface-side portion, and a second edge opposing, in the first direction, a region of the first main surface exposed from the conductive resin layer. The first edge may include an edge region in which a distance between the edge region and the first main surface in the first direction is larger than a distance between the second edge and the first main surface in the first direction.

In a configuration in which the electrically conductive particles of the conductive resin layer include metal particles, migration may occur in the external electrode. The migration is considered to occur due to the following events, for example.

An electric field acts on the metal particle included in the conductive resin layer, and the metal particle is ionized. Generated metal ion is attracted by an electric field acting on the external electrode and migrates from the conductive resin layer. The electric field acting on the metal ion includes, for example, an electric field between the external electrode and the internal electrode that are not electrically connected to each other. The metal ion migrating from the conductive resin layer reacts with, for example, an electron supplied from the internal electrode or the external electrode, and is deposited as metal on a surface of the element body.

For example, an electric field tends to be generated between the first main-surface-side portion of the conductive resin layer and the internal electrode that are not electrically connected to each other. This electric field may cause the migration as described above. However, a configuration in which the first edge of the main electrode portion includes the edge region reduces the electric field between the first main-surface-side portion and the internal electrode that are not electrically connected to each other. Therefore, this configuration suppresses the occurrence of migration.

In the one aspect, the first edge may include only the edge region.

A configuration in which the first edge includes only the edge region further reduces the electric field between the first main-surface-side portion and the internal electrode that are not electrically connected to each other. Therefore, this configuration further suppresses the occurrence of migration.

In the one aspect, the conductive resin layer may include a side-surface-side portion continuous with the one end-surface-side portion and covering a part of the side surface. The one aspect may include a dummy conductor disposed in the element body, the dummy conductor being adjacent to the side-surface-side portion in the third direction, and being electrically connected to the side-surface-side portion.

For example, an electric field tends to be generated between the side-surface-side portion of the conductive resin layer and the internal electrode that are not electrically connected to each other. This electric field may cause the migration as described above. However, a configuration including the dummy conductor reduces the electric field between the side-surface-side portion and the internal electrode that are not electrically connected to each other. Therefore, this configuration suppresses the occurrence of migration.

In the one aspect, with a plane including the first main surface as a reference plane, a length in the first direction from the reference plane to an edge of the dummy conductor opposing the second main surface may be larger than a length of the side-surface-side portion from the reference plane in the first direction.

In a configuration in which a length in the first direction from the reference plane to an edge of the dummy conductor opposing the second main surface is larger than a length of the side-surface-side portion from the reference plane in the first direction, this configuration reliably reduces the electric field between the side-surface-side portion and the internal electrode that are not electrically connected to each other.

In the one aspect, the conductive resin layer may include a side-surface-side portion continuous with the one end-surface-side portion and covering a part of the side surface. The side-surface-side portion and an internal electrode, of the plurality of internal electrodes, that is not electrically connected to the side-surface-side portion may not overlap each other, when the side-surface-side portion and the internal electrode not electrically connected to the side-surface-side portion are viewed from the third direction.

In a configuration in which the side-surface-side portion and the internal electrode not electrically connected to the side-surface-side portion do not overlap each other as described above, this configuration reduces an electric field between the side-surface-side portion and the internal electrode that are not electrically connected to each other. Therefore, this configuration suppresses the occurrence of migration.

### BRIEF DESCRIPTION OF THE DRAWINGS

FIG. 1 is a perspective view of a multilayer capacitor according to an example;

FIG. 2 is a view illustrating a cross-sectional configuration of the multilayer capacitor;

FIG. 3 is a view illustrating a cross-sectional configuration of the multilayer capacitor;

FIG. 4 is a view illustrating a cross-sectional configuration of the multilayer capacitor;

FIG. 5 is a view illustrating a configuration of a first electrode layer and a second electrode layer;

FIG. 6 is a view illustrating a cross-sectional configuration of a multilayer capacitor according to a modification of the example;

FIG. 7 is a view illustrating a configuration of a first electrode layer and a second electrode layer;

FIG. 8 is a view illustrating a configuration of the first electrode layer and the second electrode layer;

FIG. 9 is a view illustrating a cross-sectional configuration of a multilayer capacitor according to another modification of the example;

FIG. 10 is a view illustrating a configuration of a first electrode layer and a second electrode layer;

FIG. 11 is a view illustrating a configuration of the first electrode layer and the second electrode layer;

FIG. 12 is a view illustrating a cross-sectional configuration of a multilayer capacitor according to still another modification of the example;

FIG. 13 is a view illustrating a cross-sectional configuration of a multilayer capacitor according to still another modification of the example;

FIG. 14 is a view illustrating a cross-sectional configuration of a multilayer capacitor according to still another modification of the example;

FIG. 15 is a view illustrating a configuration of a first electrode layer and a second electrode layer;

FIG. 16 is a perspective view of a multilayer capacitor according to another example;

FIG. 17 is a view illustrating a cross-sectional configuration of the multilayer capacitor;

FIG. 18 is a view illustrating a cross-sectional configuration of the multilayer capacitor;

FIG. 19 is a view illustrating a configuration of a first electrode layer and a second electrode layer;

FIG. 20 is a view illustrating a cross-sectional configuration of a multilayer capacitor according to a modification of the other example; and

FIG. 21 is a view illustrating a configuration of a second electrode layer.

### DETAILED DESCRIPTION

In the following description, with reference to the drawings, the same reference numbers are assigned to the same components or to similar components having the same function, and overlapping description is omitted.

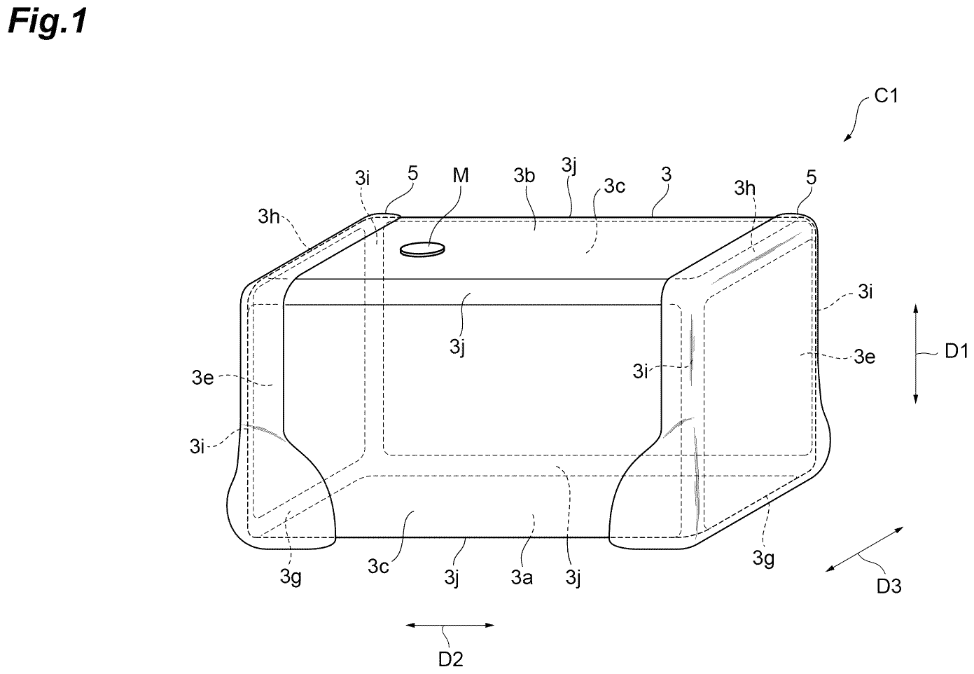

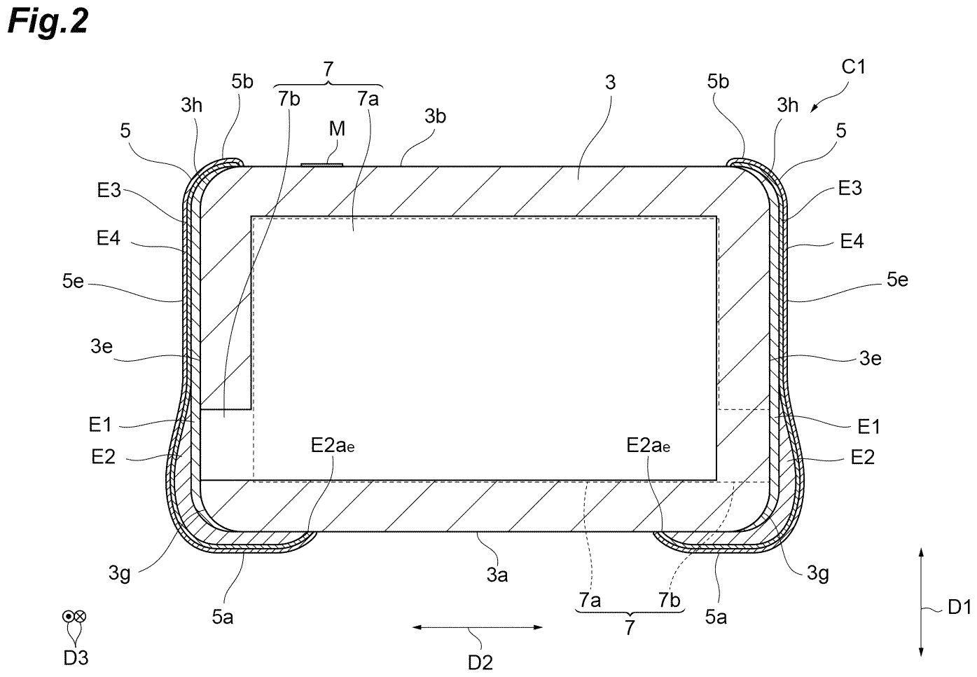

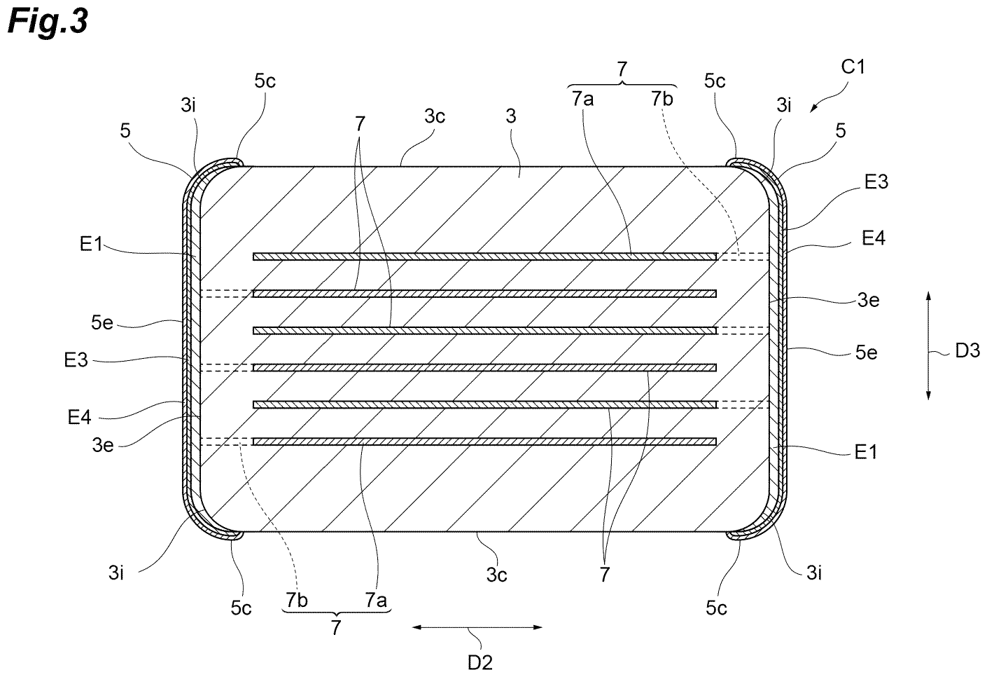

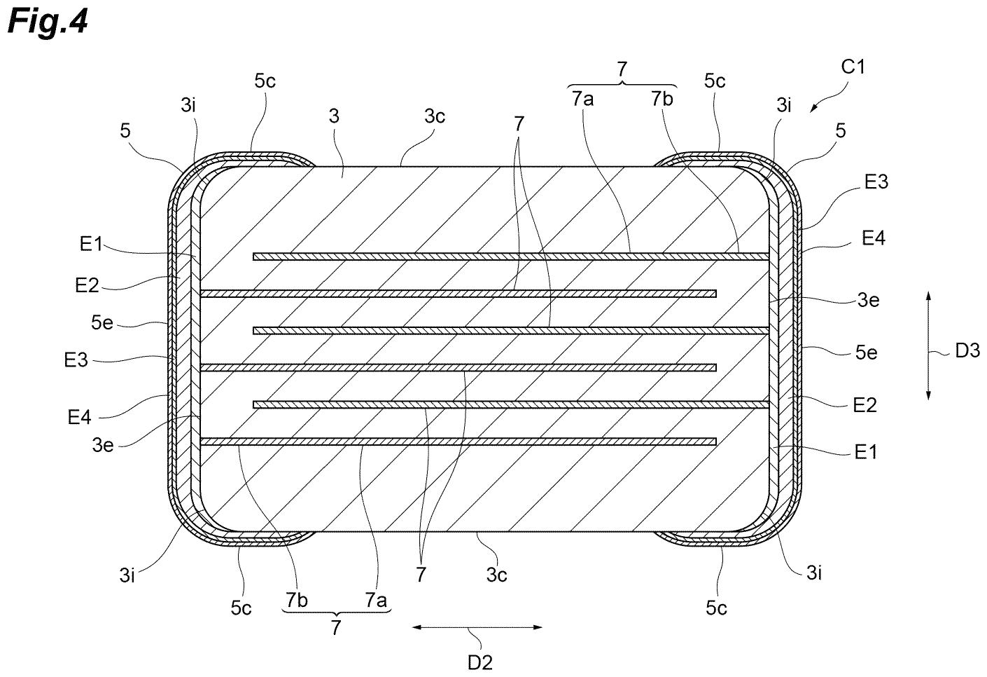

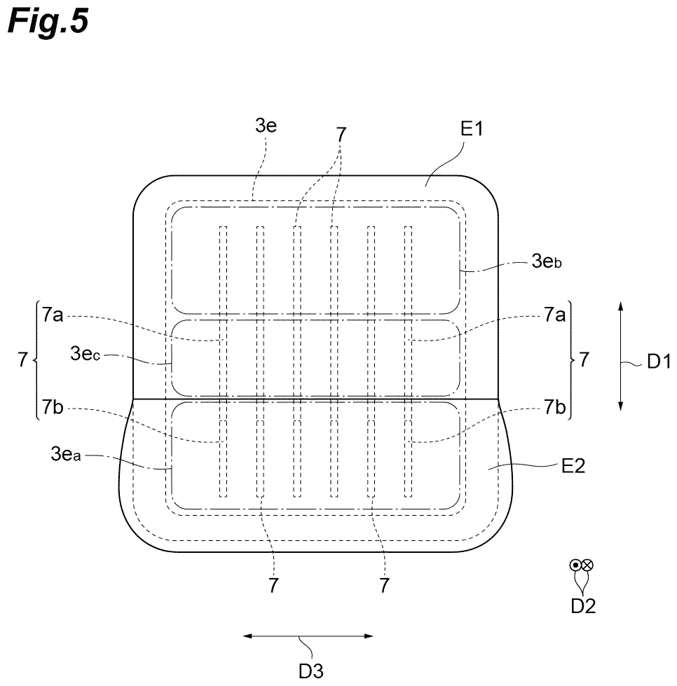

A configuration of a multilayer capacitor C1 according to an example will be described with reference to FIGS. 1 to 5. FIG. 1 is a perspective view of a multilayer capacitor according to the example. FIGS. 2, 3, and 4 are views illustrating a cross-sectional configuration of the multilayer capacitor according to the example. FIG. 5 is a view illustrating a configuration of a first electrode layer and a second electrode layer.

An electronic component includes, for example, the multilayer capacitor C1.

As illustrated in FIG. 1, the multilayer capacitor C1 includes an element body 3 of a rectangular parallelepiped shape and a plurality of external electrodes 5. For example, the multilayer capacitor C1 includes a pair of external electrodes 5. The pair of external electrodes 5 are disposed on a surface of the element body 3. The pair of external electrodes 5 are separated from each other. The rectangular parallelepiped shape includes, for example, a rectangular parallelepiped shape in which corners and ridges are chamfered, or a rectangular parallelepiped shape in which the corners and ridges are rounded.

The element body 3 includes a pair of main surfaces 3a and 3b opposing each other, a pair of side surfaces 3c opposing each other, and a pair of end surfaces 3e opposing each other. The pair of main surfaces 3a and 3b, the pair of side surfaces 3c, and the pair of end surfaces 3e each have a rectangular shape. A direction in which the pair of main surfaces 3a and 3b opposes each other includes a first direction D1. A direction in which the pair of side surfaces 3c opposes each other includes a third direction D3. A direction in which the pair of end surfaces 3e opposes each other includes a second direction D2. The main surface 3b is provided with a mark M indicating an orientation of the element body 3. The mark M may be a patterned layer formed on the main surface 3b or a region in which at least a part of the main surface 3b is colored.

The multilayer capacitor C1 is solder-mounted on an electronic device, for example. The electronic device includes, for example, a circuit board or an electronic component. In the multilayer capacitor C1, the main surface 3a opposes the electronic device. The main surface 3a is arranged to constitute a mounting surface. The main surface 3a is the mounting surface. For example, the main surface 3a may include a first main surface, and the main surface 3b may include a second main surface.

The first direction D1 includes a direction perpendicular to the main surfaces 3a and 3b, and is perpendicular to the third direction D3. The second direction D2 includes a direction parallel to each of the main surfaces 3a and 3b, and each of the side surfaces 3c, and is perpendicular to the first direction D1 and the third direction D3. The third direction D3 includes a direction perpendicular to the side surfaces 3c, and the second direction D2 includes a direction perpendicular to the end surfaces 3e.

The pair of side surfaces 3c extends in the first direction D1 to couple the pair of main surfaces 3a and 3b. The pair of side surfaces 3c extends in the second direction D2. The pair of end surfaces 3e extends in the first direction D1 to couple the pair of main surfaces 3a and 3b. The pair of end surfaces 3e extends in the third direction D3.

For example, a length of the element body 3 in the direction D2 is larger than a length of the element body 3 in the direction D1 and larger than a length of the element body 3 in the direction D3. The direction D2 includes a longitudinal direction of the element body 3. The length of the element body 3 in the direction D1 and the length of the element body 3 in the direction D3 may be equal to each other. The length of the element body 3 in the direction D1 and the length of the element body 3 in the direction D3 may be different from each other.

The length of the element body 3 in the direction D1 defines, for example, a height of the element body 3. The length of the element body 3 in the direction D3 defines, for example, a width of the element body 3. The length of the element body 3 in the direction D2 defines, for example, a longitudinal length of the element body 3. For example, the height of the element body 3 ranges from 0.1 to 3.2 mm, the width of the element body 3 ranges from 0.1 to 6.3 mm, and the longitudinal length of the element body 3 ranges from 0.2 to 7.5 mm. For example, the height of the element body 3 is 2.5 mm, the width of the element body 3 is 2.5 mm, and the longitudinal length of the element body 3 is 3.2 mm.

The element body 3 includes two ridge portions 3g, two ridge portions 3h, four ridge portions 3i, and four ridge portions 3j. The ridge portions 3g are positioned between the end surfaces 3e and the main surface 3a. The ridge portions 3h are positioned between the end surfaces 3e and the main surface 3b. The ridge portions 3i are positioned between the end surfaces 3e and the side surfaces 3c. The ridge portions 3j are positioned between the main surfaces 3a and 3b and the side surfaces 3c. For example, each of the ridge portions 3g, 3h, 3i, and 3j is rounded to curve. The element body 3 is subject to what is called a round chamfering process. The end surfaces 3e and the main surface 3a are indirectly adjacent to each other with the ridge portion 3g interposed therebetween. The end surfaces 3e and the main surface 3b are indirectly adjacent to each other with the ridge portion 3h interposed therebetween. The end surfaces 3e and the side surfaces 3c are indirectly adjacent to each other with the ridge portion 3i interposed therebetween. The main surfaces 3a and 3b and the side surfaces 3c are indirectly adjacent to each other with the ridge portion 3j interposed therebetween.

As illustrated in FIG. 5, the end surface 3e includes a plurality of regions 3eₐ, 3e_{b}, and 3e_{c}. The end surface 3e includes, for example, three regions 3eₐ, 3e_{b}, and 3e_{c} . . . . The region 3eₐ is positioned closer to the main surface 3a. The region 3e_{b} is positioned closer to the main surface 3b. The region 3e_{c} is positioned between the region 3eₐ and the region 3e_{b}. The regions 3e_{b} and 3e_{c} are positioned closer to the main surface 3b than the region 3eₐ.

The region 3eₐ, the region 3e_{b}, and the region 3e_{c} are disposed in the order of the region 3eₐ, the region 3e_{c}, and the region 3e_{b} in the direction D1. Lengths of the regions 3eₐ, 3e_{b}, and 3e_{c} in the direction D1 may be different or may be the same. The lengths of the regions 3eₐ and 3e_{b} in the direction D1 may be the same. The length of each of the regions 3eₐ, 3e_{b}, and 3e_{c} in the direction D3 may be the same as the length of the end surface 3e in the direction D3, or may be smaller than the length of the end surface 3e in the direction D3. For example, the region 3eₐ may include a partial region of the end surface 3e, and the region 3e_{b} may include an other partial region of the end surface 3e.

The element body 3 is configured through laminating a plurality of dielectric layers in the direction D3. The element body 3 includes a plurality of laminated dielectric layers. In the element body 3, a lamination direction of the plurality of dielectric layers coincides with the direction D3. Each dielectric layer includes, for example, a sintered body of a ceramic green sheet containing a dielectric material. Examples of the dielectric material include dielectric ceramics. Examples of the dielectric ceramics include BaTiO₃-based, Ba(Ti,Zr)O₃-based, or (Ba, Ca)TiO₃-based dielectric ceramics. In the actual element body 3, each of the dielectric layers is integrated to such an extent that a boundary between the dielectric layers cannot be visually recognized.

As illustrated in FIG. 2, the multilayer capacitor C1 includes a plurality of internal electrodes 7. Each of the internal electrodes 7 is connected to a corresponding external electrode 5 of the plurality of external electrodes 5. The internal electrodes 7 are electrically and physically connected to the corresponding external electrode 5. Each of the internal electrodes 7 includes an internal conductor disposed in the element body 3. Each of the internal electrodes 7 is made of an electrically conductive material that is commonly used as an internal conductor of a multilayer electronic component. The electrically conductive material includes, for example, a base metal. The electrically conductive material includes, for example, nickel (Ni) or copper (Cu). Each of the internal electrodes 7 is configured as a sintered body of electrically conductive paste containing the electrically conductive material described above. For example, the internal electrodes 7 include nickel. In FIG. 2, for the sake of explanation, the internal electrodes 7 adjacent each other are intentionally illustrated so as to deviate from each other in the first and second directions D1 and D2.

The plurality of internal electrodes 7 are disposed in different positions (layers) in the direction D3. The plurality of internal electrodes 7 are disposed in the element body 3 to oppose each other in the direction D3 with an interval therebetween. The internal electrodes 7 adjacent to each other in the direction D3 have different polarities from each other. One end of the internal electrode 7 is exposed at a corresponding end surface 3e of the pair of end surfaces 3e. Another end of the internal electrode 7 is positioned in the element body 3, and is not exposed at the end surfaces 3e. The internal electrode 7 includes the one end exposed to the corresponding end surface 3e. The plurality of internal electrodes 7 include an internal electrode 7 exposed to one end surface 3e of the pair of end surfaces 3e and an internal electrode 7 exposed to another end surface 3e of the pair of end surfaces 3e. The internal electrodes 7 exposed to the one end surface 3e and the internal electrodes 7 exposed to the other end surface 3e are alternately disposed in the direction D3. The plurality of internal electrodes 7 are disposed in the element body 3 to be distributed in the direction D3. Each of the plurality of internal electrodes 7 is positioned in a plane substantially parallel to the pair of side surfaces 3c. Each of the plurality of internal electrodes 7 is positioned in a plane substantially perpendicular to the pair of main surfaces 3a and 3b. A direction in which the internal electrodes 7 oppose each other is perpendicular to a direction parallel to the pair of side surfaces 3c.

Each internal electrode 7 includes a main electrode portion 7a and a connection portion 7b. The main electrode portion 7a and the connection portion 7b are continuous with each other. The main electrode portion 7a and the connection portion 7b are integrally formed.

The main electrode portion 7a opposes the internal electrode 7, among the plurality of internal electrodes 7, that is adjacent to in the direction D3. The main electrode portion 7a opposes the main electrode portion 7a included in the internal electrode 7 adjacent in the direction D3. The main electrode portions 7a adjacent to each other in the direction D3 oppose each other in the direction D3. The multilayer capacitor C1 exhibits capacitance between the main electrode portions 7a adjacent to each other in the direction D3.

The connection portion 7b connects the main electrode portion 7a and the corresponding external electrode 5. The connection portion 7b is directly connected to the corresponding external electrode 5. The connection portion 7b electrically connects the main electrode portion 7a and the corresponding external electrode 5. The connection portion 7b includes one end connected to the main electrode portion 7a and another end exposed at the region 3eₐ included in a corresponding end surface 3e of the pair of end surfaces 3e. The other end of the connection portion 7b is exposed only at the region 3eₐ. The other end of the connection portion 7b is not exposed at a region of the end surface 3e other than the region 3eₐ. The other end of the connection portion 7b is not exposed at the region 3e_{b} and the region 3e_{c}.

The connection portion 7b has a width smaller than a width of the main electrode portion 7a in the direction D1. The connection portion 7b is positioned closer to the main surface 3a when viewed from the direction D3. A distance between the main surface 3a and the connection portion 7b is smaller than a distance between the main surface 3b and the connection portion 7b, in the direction D1. The distance between the main surface 3b and the connection portion 7b in the direction D1 is larger than the distance between the main surface 3b and the main electrode portion 7a in the direction D1. The connection portion 7b is positioned farther from the main surface 3b than the main electrode portion 7a in the direction D1. The distance between the main surface 3a and the connection portion 7b in the direction D1 is substantially the same as a distance between the main surface 3a and the main electrode portion 7a in the direction D1. The distance between the main surface 3a and the connection portion 7b in the direction D1 may be larger than the distance between the main surface 3a and the main electrode portion 7a in the direction D1.

As illustrated in FIG. 1, the external electrodes 5 are disposed at both ends of the element body 3 in the first direction D1. Each external electrode 5 is disposed on the corresponding end surface 3e. For example, each external electrode 5 is disposed on the pair of main surfaces 3a and 3b, the pair of side surfaces 3c, and the one end surface 3e. As illustrated in FIGS. 2 to 4, the external electrode 5 includes a plurality of electrode portions 5a, 5b, 5c, and 5e. The electrode portion 5a is positioned on the main surface 3a and on the ridge portion 3g. The electrode portion 5b is positioned on the main surface 3b and on the ridge portion 3g. Each electrode portion 5c is positioned on the side surface 3c and on the ridge portion 3i. The electrode portion 5e is positioned on the end surface 3e. The external electrode 5 includes an electrode portion positioned on the ridge portion 3j.

Each external electrode 5 is formed on five surfaces of the pair of main surfaces 3a and 3b, the one end surface 3e, and the pair of side surfaces 3c as well as the ridge portions 3g, 3h, 3i, and 3j. The electrode portions 5a, 5b, 5c, and 5e adjacent to each other are physically coupled and electrically connected. The electrode portion 5e entirely covers the one end of a corresponding internal electrode 7 of the plurality of internal electrodes 7. The electrode portion 5e entirely covers the other end of the connection portion 7b included in the corresponding internal electrode 7. The electrode portion 5e is directly connected to the corresponding internal electrode 7. The external electrodes 5 are electrically connected to the corresponding internal electrodes 7. As illustrated in FIGS. 2 to 4, the external electrode 5 includes a first electrode layer E1, a second electrode layer E2, a third electrode layer E3, and a fourth electrode layer E4. The fourth electrode layer E4 includes the outermost layer of the external electrode 5. Each of the electrode portions 5a, 5c, and 5e includes the first electrode layer E1, the second electrode layer E2, the third electrode layer E3, and the fourth electrode layer E4. The electrode portion 5b includes the first electrode layer E1, the third electrode layer E3, and the fourth electrode layer E4.

The first electrode layer E1 of the electrode portion 5a is disposed on the ridge portion 3g. The first electrode layer E1 of the electrode portion 5a covers the entire ridge portion 3g. The first electrode layer E1 of the electrode portion 5a is in contact with the entire ridge portion 3g. In the electrode portion 5a, the first electrode layer E1 is in direct contact with the element body 3. The main surface 3a is exposed from the first electrode layer E1. The first electrode layer E1 of the electrode portion 5a is positioned on the ridge portion 3g. In the electrode portion 5a, the first electrode layer E1 may be formed on the main surface 3a. The first electrode layer E1 may be disposed on the main surface 3a. The first electrode layer E1 may cover a partial region, of the main surface 3a, that is positioned closer to the end surface 3e.

The second electrode layer E2 of the electrode portion 5a is disposed on both the first electrode layer E1 and the main surface 3a. In the electrode portion 5a, the second electrode layer E2 covers the first electrode layer E1 and a partial region of the main surface 3a. In the electrode portion 5a, the second electrode layer E2 is in direct contact with the first electrode layer E1 and the main surface 3a. The second electrode layer E2 of the electrode portion 5a is formed to cover the first electrode layer E1 of the electrode portion 5a. In the electrode portion 5a, the second electrode layer E2 indirectly covers the ridge portion 3g such that the first electrode layer E1 is positioned between the second electrode layer E2 and the ridge portion 3g. The second electrode layer E2 of the electrode portion 5a is positioned on the main surface 3a. Each of the second electrode layers E2 positioned on the same main surface 3a includes an edge E2a_{c}. On the same main surface 3a, the edge E2a_{c} of one second electrode layer E2 opposes the edge E2a, of another second electrode layer E2. The second electrode layer E2 of the electrode portion 5a includes, for example, a first main-surface-side portion covering the partial region of the main surface 3a.

The third and fourth electrode layers E3 and E4 of the electrode portion 5a are disposed on the second electrode layer E2. In the electrode portion 5a, the third and fourth electrode layers E3 and E4 cover the second electrode layer E2. In the electrode portion 5a, the third electrode layer E3 is in contact with the second electrode layer E2. In the electrode portion 5a, the third electrode layer E3 is in direct contact with the second electrode layer E2. In the electrode portion 5a, the third electrode layer E3 is not in direct contact with the first electrode layer E1. The third and fourth electrode layers E3 and E4 of the electrode portion 5a are positioned on the main surface 3a.

The first electrode layer E1 of the electrode portion 5b is disposed on the ridge portion 3h. The first electrode layer E1 of the electrode portion 5b covers the entire ridge portion 3h. The first electrode layer E1 of the electrode portion 5b is in contact with the entire ridge portion 3h. In the electrode portion 5b, the first electrode layer E1 is in direct contact with the element body 3. The main surface 3b is exposed from the first electrode layer E1. The first electrode layer E1 of the electrode portion 5a is positioned on the ridge portion 3h. In the electrode portion 5b, the first electrode layer E1 may be formed on the main surface 3b. The first electrode layer E1 may be disposed on the main surface 3b. The first electrode layer E1 may cover a partial region, of the main surface 3b, that is positioned closer to the end surface 3e.

The third and fourth electrode layers E3 and E4 of the electrode portion 5b are disposed on the first electrode layer E1. In the electrode portion 5b, the third and fourth electrode layers E3 and E4 cover the first electrode layer E1. In the electrode portion 5b, the third electrode layer E3 is in contact with the first electrode layer E1. In the electrode portion 5b, the third electrode layer E3 is in direct contact with the first electrode layer E1. The third and fourth electrode layers E3 and E4 of the electrode portion 5b are positioned on the main surface 3b. The electrode portion 5b does not include the second electrode layer E2. The main surface 3b is not covered with the second electrode layer E2.

The first electrode layer E1 of the electrode portion 5c is disposed on the ridge portion 3i. The first electrode layer E1 of the electrode portion 5c covers the entire ridge portion 3i. The first electrode layer E1 of the electrode portion 5c is in contact with the entire ridge portion 3i. In the electrode portion 5c, the first electrode layer E1 is in direct contact with the element body 3. The side surface 3c is exposed from the first electrode layer E1. The first electrode layer E1 of the electrode portion 5c is positioned on the ridge portion 3i. In the electrode portion 5c, the first electrode layer E1 may be formed on the side surface 3c. The first electrode layer E1 may be disposed on the side surface 3c. The first electrode layer E1 may cover a partial region, of the side surface 3c, that is positioned closer to the end surface 3e.

The second electrode layer E2 of the electrode portion 5c is disposed on both the first electrode layer E1 and the side surface 3c. In the electrode portion 5c, the second electrode layer E2 covers a partial region of the first electrode layer E1 and a partial region of the side surface 3c. In the electrode portion 5c, the second electrode layer E2 is in direct contact with the partial region of the first electrode layer E1 and the partial region of the side surface 3c. The second electrode layer E2 of the electrode portion 5c is formed to cover the partial region of the first electrode layer E1 of the electrode portion 5c. The partial region of the side surface 3c is, for example, a corner region of the side surface 3c that is positioned closer to the main surface 3a and the end surface 3e. In the electrode portion 5c, the second electrode layer E2 indirectly covers a part of the ridge portion 3i such that the first electrode layer E1 is positioned between the second electrode layer E2 and the ridge portion 3i. The first electrode layer E1 of the electrode portion 5c is covered with the second electrode layer E2 at the partial region thereof. The first electrode layer E1 of the electrode portion 5c is exposed from the second electrode layer E2 at the remaining portion excluding the partial region covered with the second electrode layer E2. The second electrode layer E2 of the electrode portion 5c is positioned on the side surface 3c. Each of the second electrode layers E2 positioned on the same side surface 3c includes an edge. On the same side surface 3c, the edge of one second electrode layer E2 opposes the edge of another second electrode layer E2. The second electrode layer E2 of the electrode portion 5c includes, for example, a side-surface-side portion covering the partial region of the side surface 3c.

The third and fourth electrode layers E3 and E4 of the electrode portion 5c are disposed on the first electrode layer E1 and the second electrode layer E2. In the electrode portion 5c, the third and fourth electrode layers E3 and E4 cover the entire second electrode layer E2, and cover the entire portion, of the first electrode layer E1, that is exposed from the second electrode layer E2. In the electrode portion 5c, the third electrode layer E3 is in contact with the entire second electrode layer E2, and is in contact with the entire portion, of the first electrode layer E1, that is exposed from the second electrode layer E2. In the electrode portion 5c, the third electrode layer E3 is in direct contact with the first electrode layer E1 and the second electrode layer E2. The third and fourth electrode layers E3 and E4 of the electrode portion 5c are positioned on the side surface 3c.

The first electrode layer E1 of the electrode portion 5e is disposed on the end surface 3e. The first electrode layer E1 of the electrode portion 5e covers the entire end surface 3e. The first electrode layer E1 of the electrode portion 5e is in contact with the entire end surface 3e. In the electrode portion 5e, the first electrode layer E1 is in direct contact with the end surface 3e.

The second electrode layer E2 of the electrode portion 5e is disposed on the first electrode layer E1. In the electrode portion 5e, the second electrode layer E2 covers a partial region of the first electrode layer E1. In the electrode portion 5e, the second electrode layer E2 is in direct contact with the partial region of the first electrode layer E1. The second electrode layer E2 of the electrode portion 5e is formed to cover the partial region of the first electrode layer E1 of the electrode portion 5e. In the electrode portion 5e, the second electrode layer E2 indirectly covers the region 3eₐ of the end surface 3e such that the first electrode layer E1 is positioned between the second electrode layer E2 and the end surface 3e. The first electrode layer E1 of the electrode portion 5e is covered with the second electrode layer E2 at the partial region thereof. The first electrode layer E1 of the electrode portion 5e is exposed from the second electrode layer E2 at the remaining portion excluding the partial region covered with the second electrode layer E2. The second electrode layer E2 of the electrode portion 5e includes, for example, one end-surface-side portion covering the region 3eₐ of the end surface 3e.

The third and fourth electrode layers E3 and E4 of the electrode portion 5e are disposed on the first electrode layer E1 and the second electrode layer E2. In the electrode portion 5e, the third and fourth electrode layers E3 and E4 cover the entire second electrode layer E2 and cover the entire portion, of the first electrode layer E1, that is exposed from the second electrode layer E2. In the electrode portion 5e, the third electrode layer E3 is in contact with the entire second electrode layer E2, and is in contact with the entire portion, of the first electrode layer E1, that is exposed from the second electrode layer E2. In the electrode portion 5e, the third electrode layer E3 is in direct contact with the first electrode layer E1 and the second electrode layer E2. The third and fourth electrode layers E3 and E4 of the electrode portion 5e are positioned on the end surface 3e.

The first electrode layer E1 is formed from sintering electrically conductive paste applied onto the surface of the element body 3. The first electrode layer E1 is formed to cover the one end surface 3e and the ridge portions 3g, 3h, 3i, and 3j. The first electrode layer E1 is formed from sintering a metal component (metal particles) included in the electrically conductive paste. The first electrode layer E1 includes, for example, a sintered metal layer. The first electrode layer E1 includes the sintered metal layer formed on the element body 3. For example, the first electrode layer E1 includes a sintered metal layer made of copper (Cu). The first electrode layer E1 may include a sintered metal layer made of nickel (Ni). The first electrode layer E1 may include a base metal. The electrically conductive paste includes, for example, particles made of copper or nickel, a glass component, an organic binder, and an organic solvent. The first electrode layers E1 included in the electrode portions 5a, 5b, 5c, and 5e are integrally formed and are continuous with each other.

The second electrode layer E2 is formed from curing conductive resin paste applied onto the first electrode layer E1. The second electrode layer E2 is formed on both the first electrode layer E1 and the element body 3. The first electrode layer E1 includes an underlying metal layer for forming the second electrode layer E2. The second electrode layer E2 includes an electrically conductive resin layer that covers the first electrode layer E1. The conductive resin paste includes, for example, a resin, an electrically conductive material, and an organic solvent. The resin includes, for example, a thermosetting resin. The conductive material includes, for example, metal particles. The metal particles include, for example, silver particles or copper particles. For example, the second electrode layer E2 includes a plurality of silver particles. The thermosetting resin is, for example, a phenol resin, an acrylic resin, a silicone resin, an epoxy resin, or a polyimide resin. The second electrode layer E2 is in contact with a part of the ridge portion 3j. The second electrode layers E2 included in the electrode portions 5a, 5c, and 5e are integrally formed and are continuous with each other.

The third electrode layer E3 is formed on the second electrode layer E2 and the first electrode layer E1 (portion exposed from the second electrode layer E2) through a plating process. The third electrode layer E3 includes, for example, a metal plating layer. The third electrode layer E3 may include a nickel plating layer. The third electrode layer E3 may include nickel. The third electrode layer E3 includes, for example, a Ni plating layer. The Ni plating layer is formed on both the second electrode layer E2 and the first electrode layer E1. The Ni plating layer has better solder leach resistance than the metal included in the second electrode layer E2. The third electrode layer E3 may be a Sn plating layer, a Cu plating layer, or an Au plating layer. The third electrode layer E3 covers the second electrode layer E2. The third electrode layers E3 included in the electrode portions 5a, 5b, 5c, and 5e are integrally formed and are continuous with each other.

The fourth electrode layer E4 is formed on the third electrode layer E3 through a plating process. The fourth electrode layer E4 includes, for example, a metal plating layer. The fourth electrode layer E4 may include a solder plating layer. The solder plating layer may include a tin (Sn) plating layer. The solder plating layer is formed on the nickel plating layer. The solder plating layer covers the nickel plating layer. The fourth electrode layer E4 may include tin. The fourth electrode layer E4 may include a tin-silver alloy (Sn—Ag) plating layer, a tin-bismuth alloy (Sn—Bi) plating layer, or a tin-copper alloy (Sn—Cu) plating layer. The fourth electrode layer E4 covers the third electrode layer E3. The fourth electrode layers E4 included in the electrode portions 5a, 5b, 5c, and 5e are integrally formed and are continuous with each other.

The third electrode layer E3 and the fourth electrode layer E4 includes a plating layer formed on the second electrode layer E2. The external electrode 5 includes the plating layer, and the plating layer includes the third electrode layer E3 and the fourth electrode layer E4. The plating layer covers the second electrode layer E2. The plating layer may include another plating layer between the second electrode layer E2 and the third electrode layer E3. The plating layer may include another plating layer between the third electrode layer E3 and the fourth electrode layer E4. The plating layer may be a single layer.

In the multilayer capacitor C1, the second electrode layer E2 continuously covers only a part of the main surface 3a, only a part of the end surface 3e, and only a part of each of the pair of side surfaces 3c. The second electrode layer E2 includes a portion continuously covering only a part of the main surface 3a, only a part of the end surface 3e, and only a part of each of the pair of side surfaces 3c. The above-described part of the end surface 3e includes the region 3eₐ. The second electrode layer E2 covers the entire ridge portion 3g, only a part of the ridge portion 3i, and only a part of the ridge portion 3j. A part of the first electrode layer E1 is exposed from the second electrode layer E2.

In the electrode portion 5e, the first electrode layer E1, the second electrode layer E2, the third electrode layer E3, and the fourth electrode layer E4 have the following configurations.

The first electrode layer E1 covers the regions 3eₐ, 3e_{b}, and 3e_{c} of the end surface 3e. The first electrode layer E1 includes a portion covering the region 3eₐ and a portion covering the regions 3e_{b} and 3e_{c}. In the first electrode layer E1, for example, the portion covering the region 3eₐ may include a first portion, and the portion covering the regions 3e_{b} and 3e_{c} may include a second portion. The first electrode layer E1 is connected to the internal electrode 7 at the portion covering the region 3eₐ. The portion of the first electrode layer E1 covering the region 3eₐ is directly connected to the connection portion 7b. The portion covering the region 3eₐ is electrically connected to the main electrode portion 7a via the connection portion 7b.

The second electrode layer E2 is positioned on the end surface 3e to cover the portion covering the region 3eₐ included in the first electrode layer E1 and to expose the portion covering the regions 3e_{b} and 3e_{c} included in the first electrode layer E1.

The third and fourth electrode layers E3 and E4 cover the portion covering the regions 3e_{b} and 3e_{c} included in the first electrode layer E1. The third and fourth electrode layers E3 and E4 cover the second electrode layer E2.

In the multilayer capacitor C1, the connection portion 7b of the internal electrode 7 is exposed at the region 3eₐ of the end surface 3e. The region 3eₐ is covered with the first electrode layer E1, and the first electrode layer E1 and the connection portion 7b of the internal electrode 7 are connected to each other.

The external electrode 5 includes the second electrode layer E2. The second electrode layer E2 is included in the electrode portion 5e. The second electrode layer E2 included in the electrode portion 5e is positioned on the end surface 3e to cover the portion, of the first electrode layer E1, that covers the region 3eₐ. The second electrode layer E2 includes the plurality of electrically conductive particles and the resin. The resin included in the second electrode layer E2 of the electrode portion 5e impedes hydrogen from migrating from the plating layer (for example, the third electrode layer E3) toward the portion, of the first electrode layer E1, that covers the region 3eₐ. Therefore, hydrogen tends not to migrate to the portion, of the first electrode layer E1, that covers the region 3eₐ and not to reach the internal electrode 7. Consequently, the multilayer capacitor C1 suppresses the deterioration of characteristics. For example, multilayer capacitor C1 suppresses a decrease in insulation resistance.

The plating layers (for example, the third and fourth electrode layers E3 and E4) are formed through the plating process as described above. In the plating process, for example, the element body 3 in which the first and second electrode layers E1 and E2 are disposed is immersed in a plating solution. In this case, the plating solution may infiltrate the element body 3. The plating solution infiltrates the element body 3, for example, from the exposed end of the internal electrode 7 or from the interface between the exposed end of the internal electrode 7 and the element body 3. In an electronic component in which the plating solution has infiltrated the element body 3, the characteristics of the electronic component may deteriorate.

In the multilayer capacitor C1, the second electrode layer E2 included in the electrode portion 5e is positioned on the end surface 3e to cover the portion, of the first electrode layer E1, that covers the region 3eₐ. Therefore, the second electrode layer E2 is positioned on an infiltration path of the plating solution to the exposed end of the internal electrode 7, i.e., the other end of the connection portion 7b. The second electrode layer E2 impedes the plating solution from infiltrating into the element body 3. Consequently, the multilayer capacitor C1 suppresses the deterioration of characteristics.

The second electrode layer E2 includes the resin. The second electrode layer E2 has an electric resistance larger than an electric resistance of the first electrode layer E1 that does not include the resin. The multilayer capacitor C1 in which the external electrode 5 includes the second electrode layer E2 may increase the ESR.

The plating layer covers the portion of the first electrode layer E1 that covers the regions 3e_{b} and 3e_{c}. The portion of the first electrode layer E1 that covers the regions 3e_{b} and 3e_{c} is connected to the plating layer without the second electrode layer E2 being interposed. Therefore, in the multilayer capacitor C1, the external electrode 5 includes an electric current path not including the second electrode layer E2. Consequently, the multilayer capacitor C1 suppresses an increase in the ESR.

In a configuration in which the multilayer capacitor C1 is solder-mounted on an electronic device, an external force acting on the multilayer capacitor C1 from the electronic device may act on the element body 3 through the external electrode 5. The external force is transmitted to the external electrode 5 from, for example, a solder fillet formed during solder-mounting. The electronic device includes, for example, a circuit board or an electronic component.

In the multilayer capacitor C1, the external electrode 5 includes the second electrode layer E2. Therefore, the external force tends not to act on the element body 3 from the external electrode 5. Consequently, the multilayer capacitor C1 suppresses cracks from occurring in the element body 3.

In the multilayer capacitor C1, the main surface 3b may be provided with the mark M indicating the orientation of the element body 3.

In a configuration in which the first electrode layer E1 entirely covers the end surface 3e, the position of the region 3eₐ tends not to be recognized. In a configuration in which the main surface 3b is provided with the mark M, the surface opposing the surface that is provided with the mark M is identified as the main surface 3a. Therefore, the position of the region 3eₐ positioned closer to the main surface 3a can be easily identified. Consequently, in a configuration in which the main surface 3b is provided with the mark M, the second electrode layer E2 can be formed at an appropriate position when forming the second electrode layer E2.

In the multilayer capacitor C1, the first electrode layer E1 may entirely cover the end surface 3e.

In a configuration in which the first electrode layer E1 entirely covers the end surface 3e, the first electrode layer E1 protects the end surface 3e.

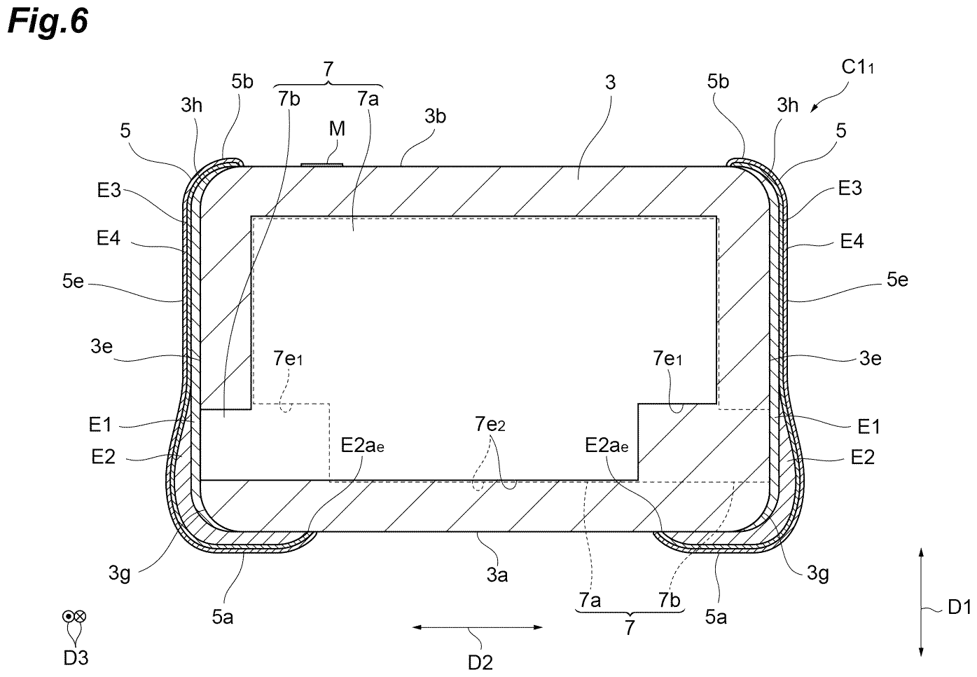

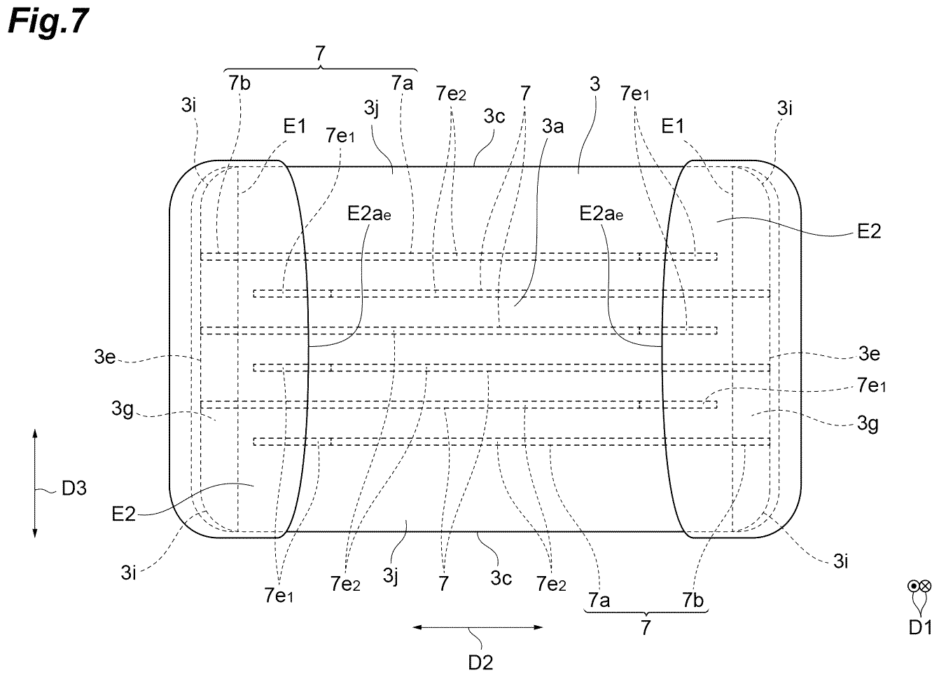

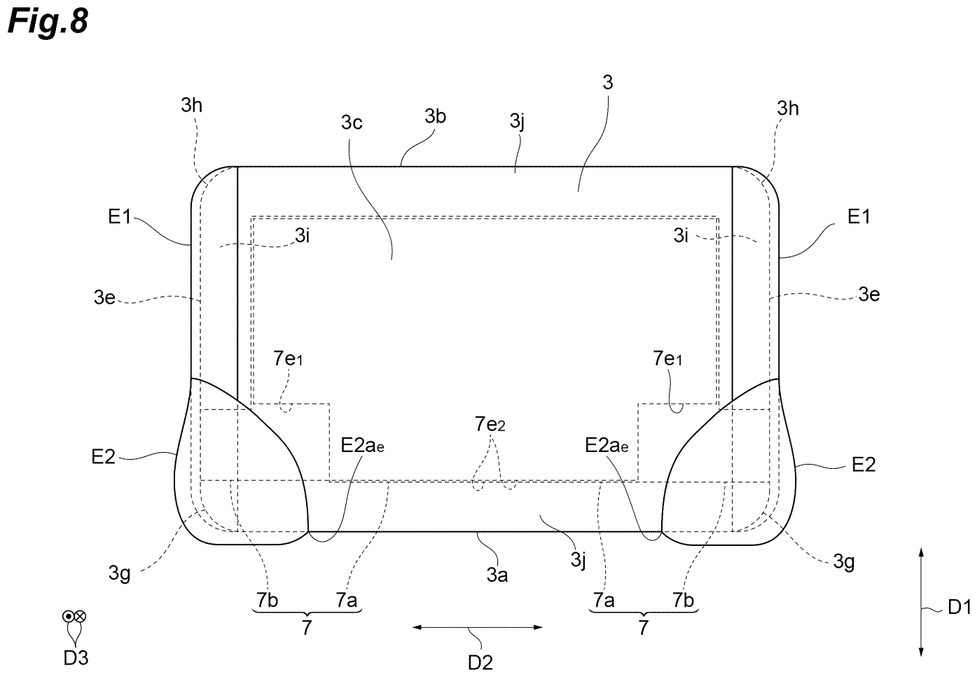

A configuration of a multilayer capacitor C1₁ according to a modification of the present example will be described with reference to FIGS. 6 to 8. FIG. 6 is a view illustrating a cross-sectional configuration of a multilayer capacitor according to the modification. FIGS. 7 and 8 are views illustrating a configuration of a first electrode layer and a second electrode layer.

The multilayer capacitor C1₁ is generally similar to or the same as the multilayer capacitor C1 described above. However, the multilayer capacitor C1₁ is different from the multilayer capacitor C1 in a configuration of the internal electrode 7. Hereinafter, differences between the multilayer capacitor C1₁ and the multilayer capacitor C1 will be mainly described. In FIG. 6, for the sake of explanation, the internal electrodes 7 adjacent each other are intentionally illustrated so as to deviate from each other in the first and second directions D1 and D2.

An electronic component includes, for example, the multilayer capacitor C1₁.

The internal electrode 7 included in the multilayer capacitor C1₁ includes a main electrode portion 7a having the following configuration.

As illustrated in FIG. 6, the main electrode portion 7a is shaped such that a corner closer to the main surface 3a on the other end side is cut out. The main electrode portion 7a includes an edge 7e₁ and an edge 7e₂ that oppose the main surface 3a. The edge 7e₁ is positioned on the other end side of the internal electrode 7. The edge 7e₁ opposes, in the direction D1, the region of the main surface 3a that is covered with the second electrode layer E2. The edge 7e₂ opposes, in the direction D1, the region of the main surface 3a that is exposed from the second electrode layer E2. The edge 7e₁ includes an edge region in which a distance between the edge region and the main surface 3a in the direction D1 is larger than a distance between the edge 7e₂ and the main surface 3a in the direction D1. The edge 7e₁ may include only the edge region in which the distance between the edge region and the main surface 3a in the direction D1 is larger than the distance between the edge 7e₂ and the main surface 3a in the direction D1. In this configuration, throughout the entire edge 7e₁, the distance between the edge 7e₁ and the main surface 3a in the direction D1 is larger than the distance from the edge 7e₂ to the main surface 3a in the direction D1. For example, the edge 7e₁ may include a first edge, and the edge 7e₂ may include a second edge.

The main electrode portion 7a includes an electrode portion including the edge 7e, and an electrode portion including the edge 7e₂. The electrode portion including the edge 7e₁ includes the other end of the internal electrode 7. The electrode portion including the edge 7e₂ is positioned between the electrode portion including the edge 7e₁ and the connection portion 7b in the direction D2. As illustrated in FIG. 7, when the internal electrode 7 and the second electrode layer E2 that are not electrically connected to each other are viewed from the direction D1, the electrode portion including the edge 7e₁ overlaps the second electrode layer E2, and the electrode portion including the edge 7e₂ does not overlap the second electrode layer E2. With a plane that includes the end surface 3e opposing the other end of the internal electrode 7 as a reference plane, a distance from the reference plane to the electrode portion including the edge 7e₂ is larger than a distance from the reference plane to the edge E2a, of the second electrode layer E2.

As illustrated in FIG. 8, when the second electrode layer E2 included in the electrode portion 5c and the internal electrode 7, among the plurality of internal electrodes 7, that is not electrically connected to the second electrode layer E2 included in the electrode portion 5c are viewed from the direction D3, the second electrode layer E2 included in the electrode portion 5c and the internal electrode 7 that is not electrically connected to the second electrode layer E2 included in the electrode portion 5c do not overlap each other.

The second electrode layer E2 may be included in the electrode portion 5e and the electrode portion 5a. The second electrode layer E2 included in the electrode portion 5e may be continuous to the second electrode layer E2 included in the electrode portion 5a. The main electrode portion 7a may include the edges 7e₁ and 7e₂ described above. The edge 7e₁ may include the edge region in which the distance between the edge region and the main surface 3a in the direction D1 is larger than the distance between the edge 7e₂ and the main surface 3a in the direction D1.

In a configuration in which the second electrode layer E2 includes the plurality of metal particles as the electrically conductive particles, migration may occur in the external electrode 5. The migration is considered to occur due to the following events, for example.

An electric field acts on the metal particle included in the second electrode layer E2, and the metal particle is ionized. Generated metal ion is attracted by an electric field acting on the external electrode 5 and migrates from the second electrode layer E2. The electric field acting on the metal ion includes, for example, an electric field between the external electrode 5 and the internal electrode 7 that are not electrically connected to each other. The metal ion migrating from the second electrode layer E2 reacts with, for example, an electron supplied from the internal electrode 7 or the external electrode 5, and is deposited as metal on the surface of the element body 3.

For example, an electric field tends to be generated between the second electrode layer E2 included in the electrode portion 5a and the internal electrode 7 that are not electrically connected to each other. This electric field may cause the migration as described above. However, in a configuration in which the edge 7e₁ of the main electrode portion 7a includes the edge region in which the distance between the edge region and the main surface 3a in the direction D1 is larger than the distance between the edge 7e₂ and the main surface 3a in the direction D1, this configuration reduces the electric field between the second electrode layer E2 included in the electrode portion 5a and the internal electrode 7 that are not electrically connected to each other. Therefore, this configuration suppresses the occurrence of migration.

The edge 7e₁ may include only the edge region described above.

In a configuration in which the edge 7e₁ includes only the edge region described above, this configuration further reduces the electric field between the second electrode layer E2 included in the electrode portion 5a and the internal electrode 7 that are not electrically connected to each other. Therefore, this configuration further suppresses the occurrence of migration.

Throughout the entire edge 7e₁, the distance the edge 7e, and the main surface 3a in the direction D1 may not be larger than the distance from the edge 7e₂ to the main surface 3a in the direction D1. For example, in only a part of the edge 7e₁, the distance the edge 7e, and the main surface 3a in the direction D1 may be larger than the distance from the edge 7e₂ to the main surface 3a in the direction D1. Even in a configuration in which, in only a part of the edge 7e₁, the distance the edge 7e₁ and the main surface 3a in the direction D1 is larger than the distance from the edge 7e₂ to the main surface 3a in the direction D1, this configuration can reduce the electric field between the second electrode layer E2 included in the electrode portion 5a and the internal electrode 7.

The second electrode layer E2 may be included in the electrode portion 5e and the electrode portion 5c. When the second electrode layer E2 included in the electrode portion 5c and the internal electrode 7 that is not electrically connected to the second electrode layer E2 included in the electrode portion 5c are viewed from the direction D3, the second electrode layer E2 included in the electrode portion 5c and the internal electrode 7 that is not electrically connected to the second electrode layer E2 included in the electrode portion 5c may not overlap each other.

For example, an electric field tends to be generated between the second electrode layer E2 included in the electrode portion 5c and the internal electrode 7 that are not electrically connected to each other. This electric field may cause the migration as described above. However, in a configuration in which the second electrode layer E2 included in the electrode portion 5c and the internal electrode 7 that is not electrically connected to the second electrode layer E2 included in the electrode portion 5c do not overlap each other when viewed from the direction D3, this configuration reduces the electric field between the second electrode layer E2 included in the electrode portion 5c and the internal electrode 7 that are not electrically connected to each other. Therefore, this configuration suppresses the occurrence of migration.

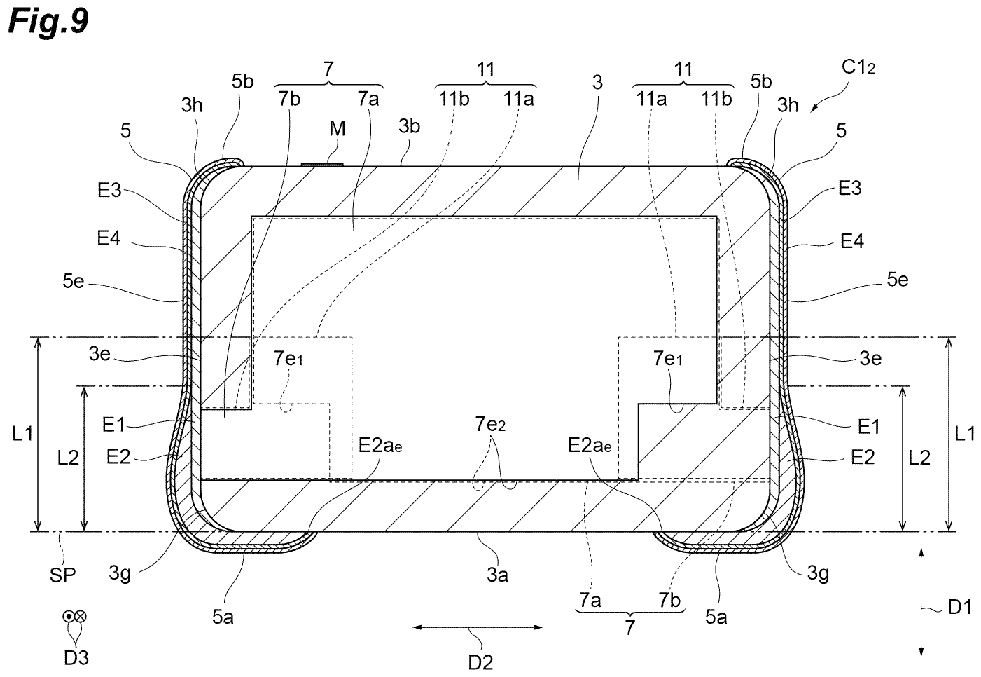

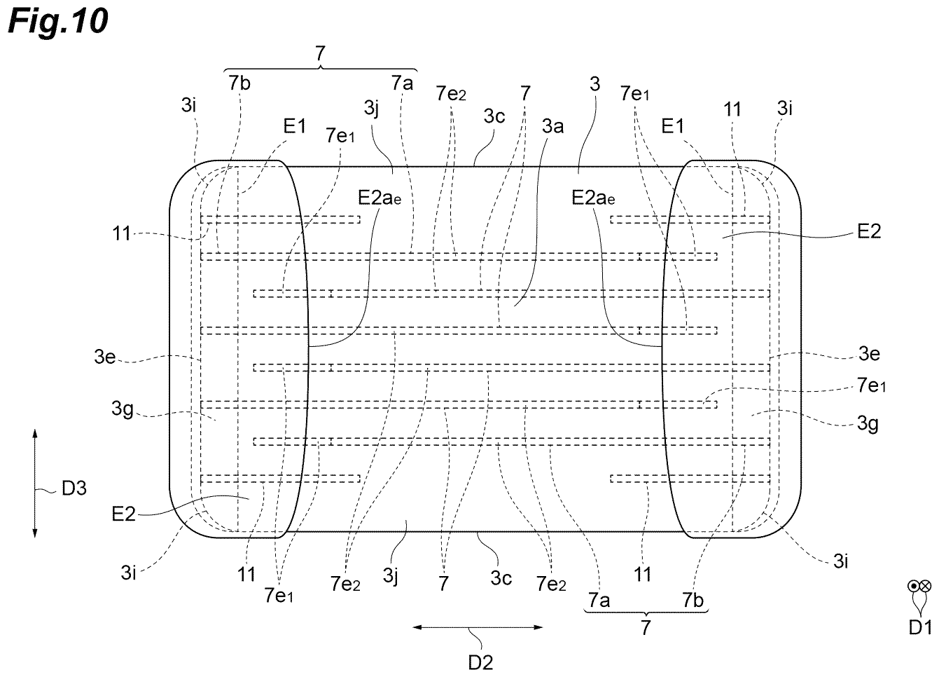

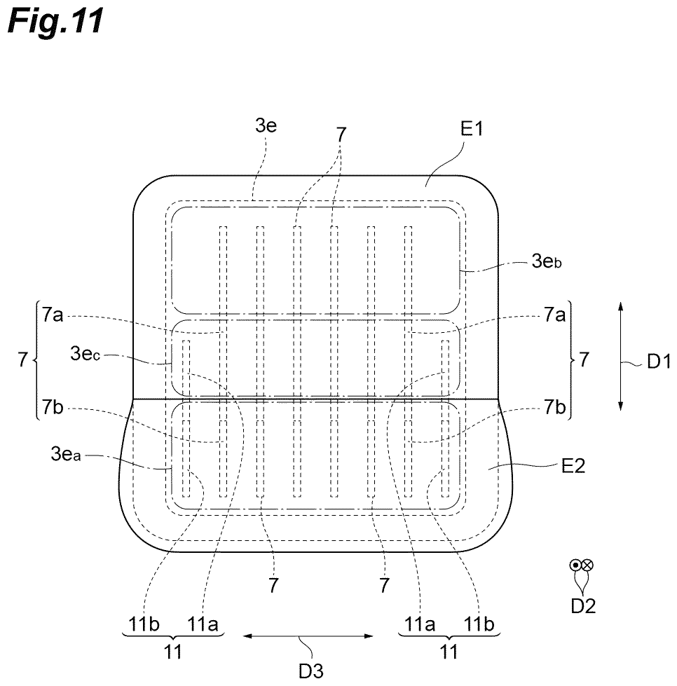

A configuration of a multilayer capacitor C1₂ according to another modification of the present example will be described with reference to FIGS. 9 to 11. FIG. 9 is a view illustrating a cross-sectional configuration of a multilayer capacitor according to the other modification. FIGS. 10 and 11 are views illustrating a configuration of a first electrode layer and a second electrode layer.

The multilayer capacitor C1₂ is generally similar to or the same as the multilayer capacitor C1₁. However, the multilayer capacitor C1₂ is different from the multilayer capacitor C1₁ in that the multilayer capacitor C1₂ includes a plurality of conductors 11. Hereinafter, differences between the multilayer capacitor C1₂ and the multilayer capacitor C1₁ will be mainly described. In FIG. 9, for the sake of explanation, the internal electrodes 7 adjacent each other are intentionally illustrated so as to deviate from each other in the first and second directions D1 and D2, and the internal electrode 7 and the conductor 11 that are adjacent each other are intentionally illustrated so as to deviate from each other in the first and second directions D1 and D2.

An electronic component includes, for example, the multilayer capacitor C1₂.

In the other modification, as illustrated in FIGS. 9 and 10, the multilayer capacitor C1₂ includes the plurality of conductors 11. The plurality of conductors 11 are disposed in the element body 3. Each of the conductors 11 is made of an electrically conductive material that is commonly used as an internal conductor of a multilayer electronic component. The electrically conductive material includes, for example, a base metal. The electrically conductive material includes, for example, nickel (Ni) or copper (Cu). Each of the conductors 11 is configured as a sintered body of electrically conductive paste containing the electrically conductive material described above. For example, the conductors 11 include nickel.

The conductor 11 is adjacent to the side surface 3c in the direction D3. The conductor 11 is positioned between the side surface 3c and the internal electrode 7 that is positioned on the outermost side in the direction D3 among the plurality of internal electrodes 7. The conductor 11 is adjacent to the second electrode layer E2 included in the electrode portion 5c in the direction D3. When the second electrode layer E2 included in the electrode portion 5c and the conductor 11 that is not electrically connected to the second electrode layer E2 included in the electrode portion 5c are viewed from the direction D3, the second electrode layer E2 included in the electrode portion 5c and the conductor 11 that is not electrically connected to the second electrode layer E2 included in the electrode portion 5c overlap each other.

The conductor 11 includes one end that is exposed at a corresponding end surface 3e of the pair of end surfaces 3e, and another end that is positioned in the element body 3 and is not exposed to the end surfaces 3e. The conductor 11 includes a main conductor portion 11a and a connection portion 11b. The main conductor portion 11a and the connection portion 11b are continuous with each other. The main conductor portion 11a and the connection portion 11b are integrally formed.

The main conductor portion 11a opposes the main electrode portion 7a included in the internal electrode 7 adjacent to the conductor 11 in the direction D3.

The connection portion 11b is positioned on one end side of the conductor 11. The connection portion 11b is connected to a corresponding external electrode 5 of the plurality of external electrodes 5. The connection portion 11b connects the main conductor portion 11a and the corresponding external electrode 5. The connection portion 11b includes one end exposed to the region 3eₐ included in the corresponding end surface 3e. As illustrated in FIG. 11, the one end of the connection portion 11b is exposed only in the region 3eₐ. The one end of the connection portion 11b is not exposed to a region of the end surface 3e other than the region 3eₐ. The one end of the connection portion 11b is not exposed to the region 3e_{b} and the region 3e . . . . The one end of the connection portion 11b is entirely covered with the electrode portion 5e included in the corresponding external electrode 5. The conductor 11 is directly connected to the corresponding external electrode 5. The conductor 11 is electrically connected to the corresponding external electrode 5.

In a configuration in which the internal electrode 7 and the conductor 11 that are adjacent to each other in the direction D3 are electrically connected to each other, the multilayer capacitor C1₂ may not exhibit capacitance between the internal electrode 7 and the conductor 11 that are adjacent to each other in the direction D3. The conductor 11 includes a dummy conductor that tends not to contribute to the formation of capacitance. In a configuration in which the internal electrode 7 and the conductor 11 that are adjacent to each other in the direction D3 are not electrically connected to each other, the multilayer capacitor C1₂ may exhibit capacitance between the internal electrode 7 and the conductor 11 that are adjacent to each other in the direction D3.

The connection portion 11b has a width smaller than a width of the main conductor portion 11a in the direction D1. The connection portion 11b is positioned closer to the main surface 3a when viewed from the direction D3. A distance between the main surface 3a and the connection portion 11b in the direction D1 is smaller than a distance between the main surface 3b and the connection portion 11b. A distance between the main surface 3b and the connection portion 11b in the direction D1 is larger than a distance between the main surface 3b and the main conductor portion 11a in the direction D1. The connection portion 11b is positioned farther from the main surface 3b than the main conductor portion 11a in the direction D1. A distance between the main surface 3a and the connection portion 11b in the direction D1 is substantially the same as a distance between the main surface 3a and the other-end-side portion of the conductor 11 in the direction D1.

With a plane including the main surface as a reference plane SP, a length L1 in the direction D1 from the reference plane SP to an edge of the conductor 11 that opposes the main surface 3b is larger than a length L2 of the second electrode layer E2 included in the electrode portion 5c from the reference plane SP in the direction D1. The edge of the conductor 11 that opposes the main surface 3b includes, for example, the edge of the main conductor portion 11a that opposes the main surface 3b. The length L1 may be substantially the same as a length L3 in the direction D1 from the reference plane SP to the edge of the internal electrode 7 that opposes the main surface 3b. The edge of the inner electrode 7 that opposes the main surface 3b includes, for example, the edge of the main electrode portion 7a that opposes the main surface 3b.

The multilayer capacitor C1₂ may include the conductor 11 that is disposed in the element body 3, is adjacent to the second electrode layer E2 included in the electrode portion 5c in the direction D3, and is electrically connected to the second electrode layer E2 included in the electrode portion 5c.

A configuration including the conductor 11 reduces the electric field between the internal electrode 7 and the second electrode layer E2 included in the electrode portion 5c that are not electrically connected to each other. Therefore, this configuration suppresses the occurrence of migration.

The length L1 may be larger than the length L2.

A configuration in which the length L1 is larger than the length L2 reliably reduces the electric field between the second electrode layer E2 included in the electrode portion 5c and the internal electrode 7 that are not electrically connected to each other.

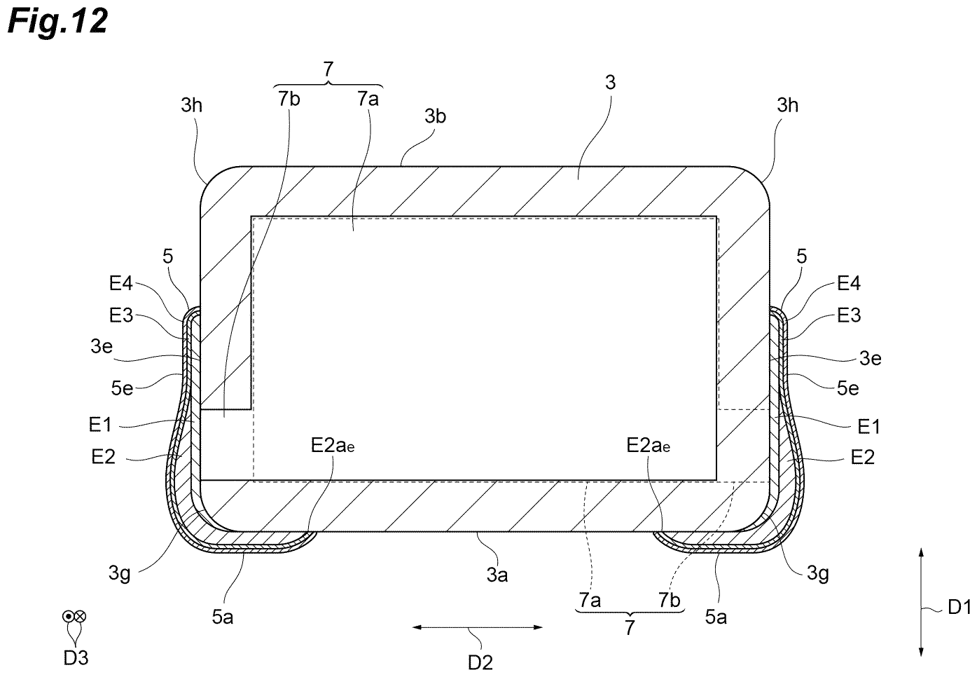

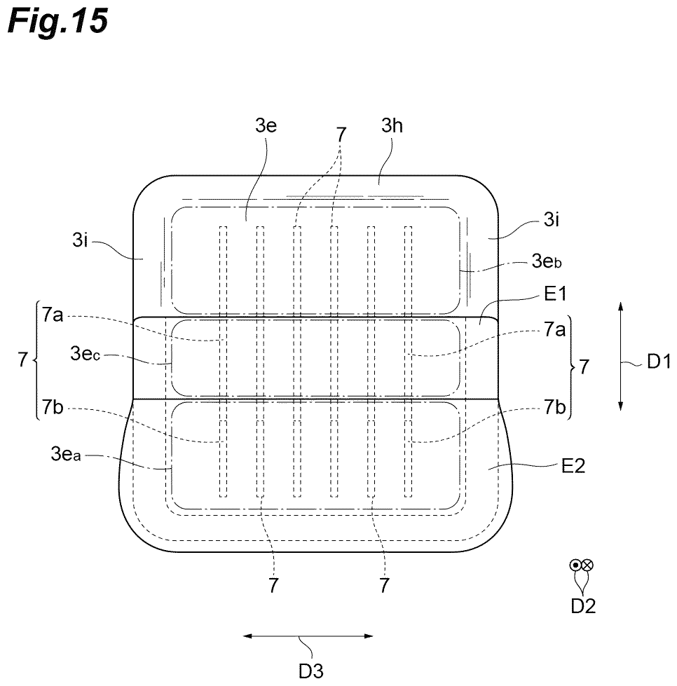

A configuration of a multilayer capacitor according to still another modification of the present example will be described with reference to FIGS. 12 to 15. FIGS. 12, 13, and 14 are views illustrating a cross-sectional configuration of a multilayer capacitor according to the still another modification. FIG. 15 is a view illustrating a configuration of a first electrode layer and a second electrode layer.

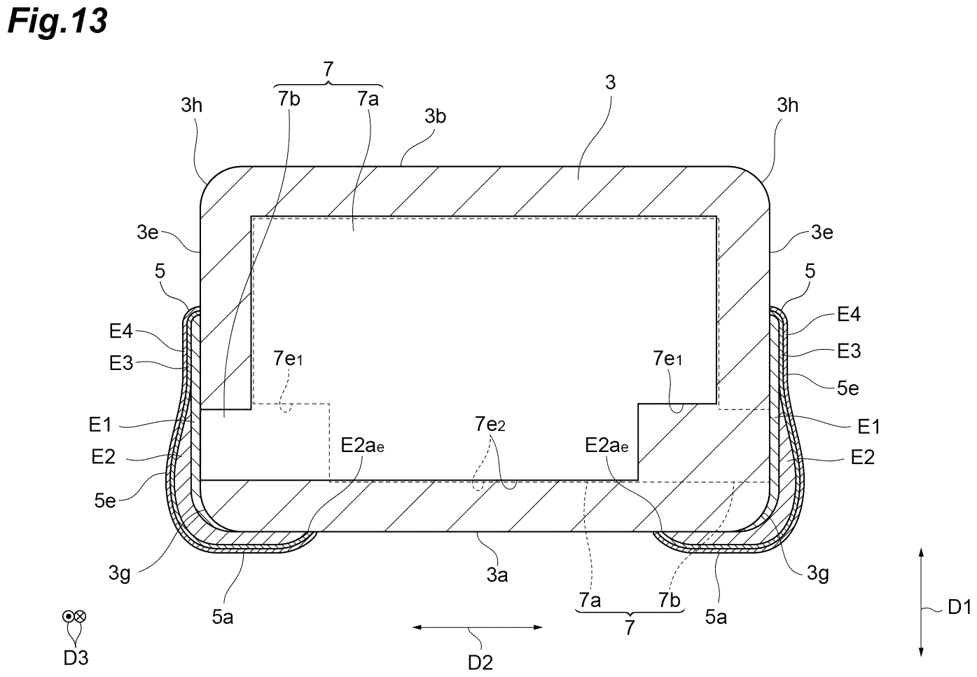

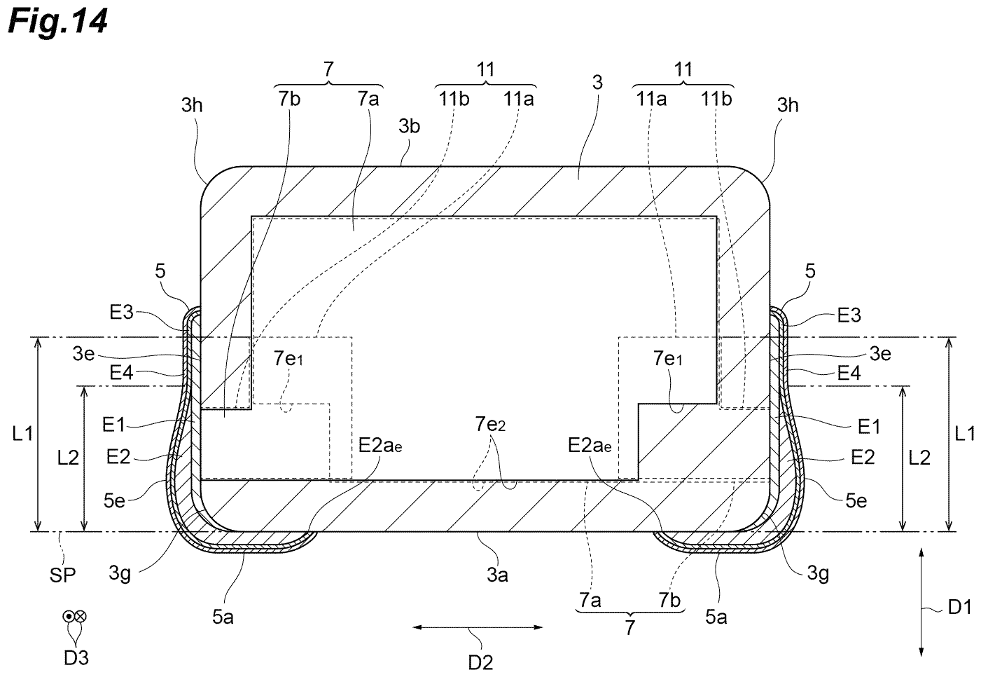

The multilayer capacitor illustrated in FIG. 12 is generally similar to or the same as the multilayer capacitor C1 described above. However, the multilayer capacitor illustrated in FIG. 12 is different from the multilayer capacitor C1 in a configuration of the external electrode 5. The multilayer capacitor illustrated in FIG. 13 is generally similar to or the same as the multilayer capacitor C1₁ described above. However, the multilayer capacitor illustrated in FIG. 13 is different from the multilayer capacitor C1₁ in a configuration of the external electrode 5. The multilayer capacitor illustrated in FIG. 14 is generally similar to or the same as the multilayer capacitor C1₂ described above. However, the multilayer capacitor illustrated in FIG. 14 is different from the multilayer capacitor C1₂ in a configuration of the external electrode 5. In FIGS. 12 to 14, for the sake of explanation, the internal electrodes 7 adjacent each other are intentionally illustrated so as to deviate from each other in the first and second directions D1 and D2.

An electronic component includes, for example, each of the multilayer capacitors illustrated in FIGS. 12 to 14.

As illustrated in FIGS. 12 to 14, the external electrode 5 may not include the electrode portion 5b. The external electrodes 5 may include only the electrode portions 5a, 5c, and 5e. In a configuration in which the external electrode 5 does not include the electrode portion 5b, the external electrode 5 continuously covers only a part of the main surface 3a, only a part of the end surface 3e, and only a part of each of the pair of side surface 3c. The main surface 3b is entirely exposed from the external electrode 5. In the side surface 3c, only a corner region closer to the main surface 3a and the end surface 3e are covered with the external electrode 5. As illustrated in FIG. 15, the region 3e_{b} of the end surface 3e is entirely exposed from the external electrode 5.

In the electrode portion 5e, the first electrode layer E1 entirely covers the region 3eₐ. The region 3e_{b} is exposed from the first electrode layer E1. In the electrode portion 5e, the first electrode layer E1 covers at least a portion of the region 3e_{c} closer to the region 3eₐ. The first electrode layer E1 may entirely cover the region 3e_{c}. The first electrode layer E1 includes a portion covering the region 3eₐ and a portion covering the region 3e_{c}, but does not include a portion covering the region 3e_{b}.

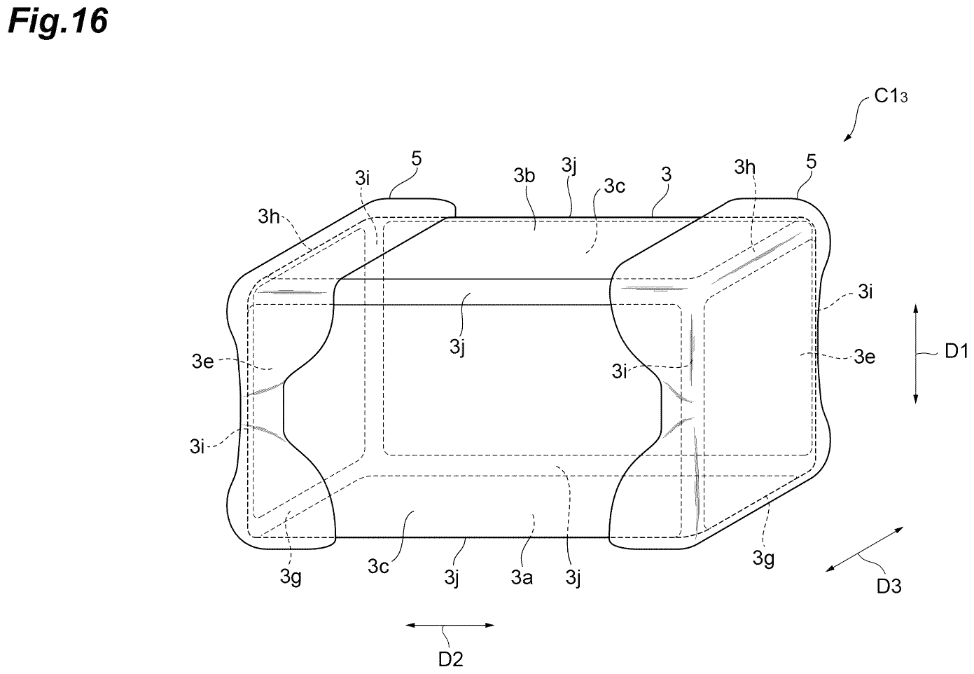

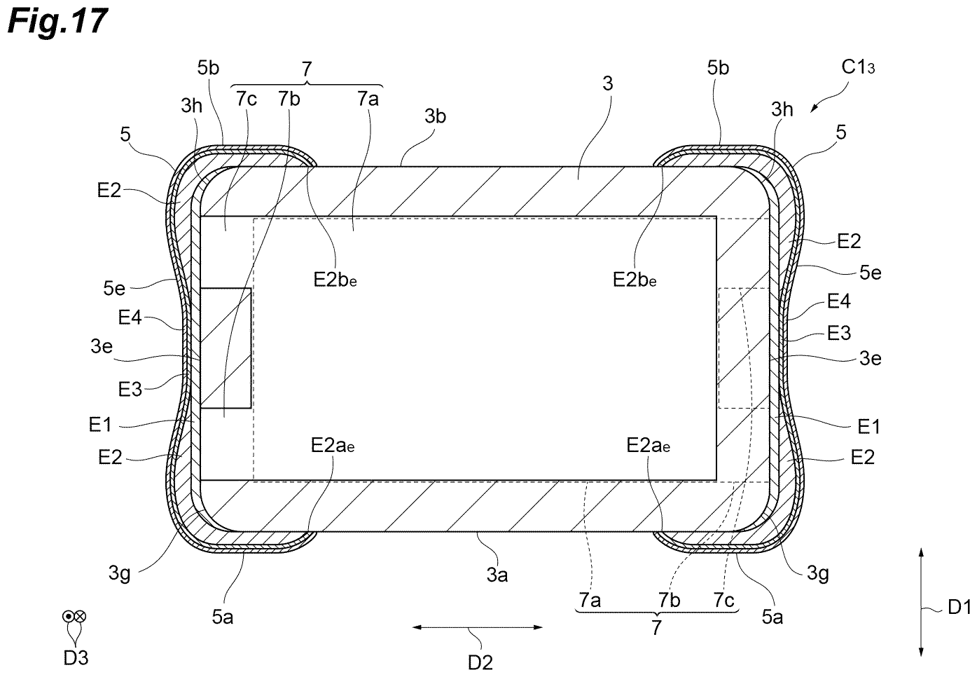

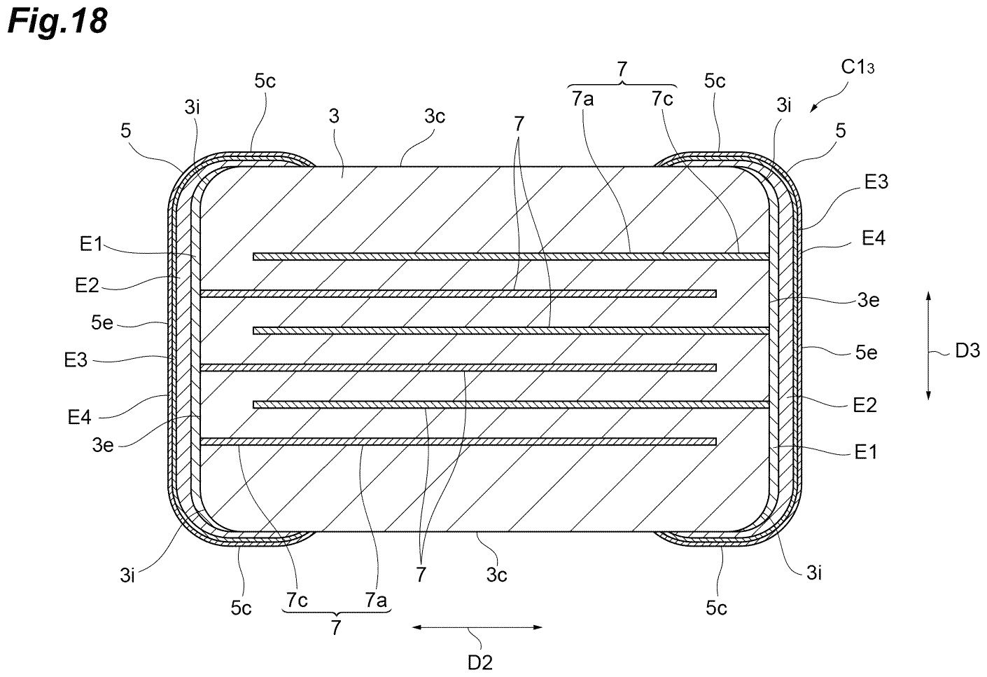

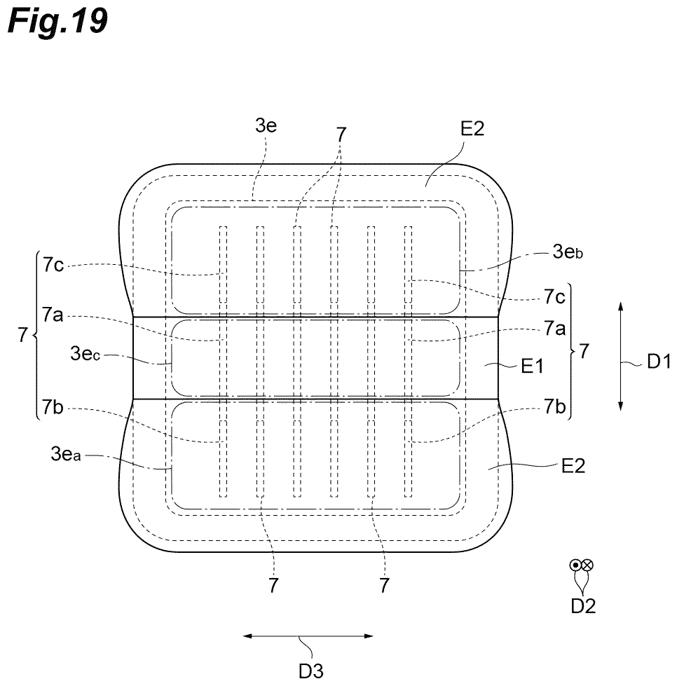

A configuration of a multilayer capacitor C1₃ according to another example will be described with reference to FIGS. 16 to 19. FIG. 16 is a perspective view of a multilayer capacitor according to the other example. FIGS. 17 and 18 are views illustrating a cross-sectional configuration of the multilayer capacitor according to the other example. FIG. 19 is a view illustrating a configuration of a first electrode layer and a second electrode layer.

The multilayer capacitor C1₃ is generally similar to or the same as the multilayer capacitor C1 described above. However, the multilayer capacitor C1₃ is different from the multilayer capacitor C1 in a configuration of the external electrode 5 and the internal electrode 7. Hereinafter, differences between the multilayer capacitor C1₃ and the multilayer capacitor C1 will be mainly described. In FIG. 17, for the sake of explanation, the internal electrodes 7 adjacent each other are intentionally illustrated so as to deviate from each other in the first and second directions D1 and D2.

An electronic component includes, for example, the multilayer capacitor C1₃.

As illustrated in FIGS. 16 to 19, the multilayer capacitor C1₃, like the multilayer capacitor C1, includes the element body 3 of a rectangular parallelepiped shape, the pair of external electrodes 5, and the plurality of internal electrode 7. In the multilayer capacitor C1₃, the main surface 3a or the main surface 3b opposes the electronic device. The main surface 3a or the main surface 3b is arranged to constitute a mounting surface. The main surface 3a or the main surface 3b is the mounting surface. For example, the main surface 3a may include a first main surface, and the main surface 3b may include a second main surface.

Each of the internal electrodes 7 includes the main electrode portion 7a, the connection portion 7b, and a connection portion 7c. The main electrode portion 7a, the connection portion 7b, and the connection portion 7c are continuous with each other. The main electrode portion 7a, the connection portion 7b, and the connection portion 7c are integrally formed.

The connection portion 7c connects the main electrode portion 7a and a corresponding external electrode 5 of the pair of external electrodes 5. The connection portion 7c is directly connected to the corresponding external electrode 5. The connection portion 7c electrically connects the main electrode portion 7a and the corresponding external electrode 5. The connection portion 7c includes one end connected to the main electrode portion 7a and another end exposed at the region 3e_{b} included in a corresponding end surface 3e of the pair of end surfaces 3e. The other end of the connection portion 7c is exposed only at the region 3e_{b}. The other end of the connection portion 7c is not exposed at a region of the end surface 3e other than the region 3e_{b}. The other end of the connection portion 7c is not exposed at the region 3eₐ and the region 3e_{c}. The internal electrode 7 is not exposed in the region 3e_{c}.

The connection portion 7c has a width smaller than the width of the main electrode portion 7a in the direction D1. The connection portion 7c is positioned closer to the main surface 3b when viewed from the direction D3. A distance between the main surface 3b and the connection portion 7c is smaller than a distance between the main surface 3a and the connection portion 7c, in the direction D1. The distance between the main surface 3a and the connection portion 7c in the direction D1 is larger than the distance between the main surface 3a and the main electrode portion 7a in the direction D1. The connection portion 7c is positioned farther from the main surface 3a than the main electrode portion 7a in the direction D1. The distance between the main surface 3b and the connection portion 7c in the direction D1 is substantially the same as a distance between the main surface 3b and the main electrode portion 7a in the direction D1. The distance between the main surface 3b and the connection portion 7c in the direction D1 may be larger than the distance between the main surface 3b and the main electrode portion 7a in the direction D1.

The electrode portion 5b includes the first electrode layer E1, the second electrode layer E2, the third electrode layer E3, and the fourth electrode layer E4.

The second electrode layer E2 of the electrode portion 5b is disposed on both the first electrode layer E1 and the main surface 3b. In the electrode portion 5b, the second electrode layer E2 covers the first electrode layer E1 and a partial region of the main surface 3b. In the electrode portion 5b, the second electrode layer E2 is in direct contact with the first electrode layer E1 and the main surface 3b. The second electrode layer E2 of the electrode portion 5b is formed to cover the first electrode layer E1 of the electrode portion 5b. In the electrode portion 5b, the second electrode layer E2 indirectly covers the ridge portion 3h such that the first electrode layer E1 is positioned between the second electrode layer E2 and the ridge portion 3h. The second electrode layer E2 of the electrode portion 5b is positioned on the main surface 3b. Each of the second electrode layers E2 positioned on the same main surface 3b includes an edge E2b_{c}. On the same main surface 3b, the edge E2b_{c} of one second electrode layer E2 opposes the edge E2b_{c} of another second electrode layer E2. The second electrode layer E2 of the electrode portion 5b includes, for example, a second main-surface-side portion covering the partial region of the main surface 3b.

The third and fourth electrode layers E3 and E4 of the electrode portion 5b are disposed on the second electrode layer E2. In the electrode portion 5b, the third and fourth electrode layers E3 and E4 cover the second electrode layer E2. In the electrode portion 5b, the third electrode layer E3 is in contact with the second electrode layer E2. In the electrode portion 5b, the third electrode layer E3 is in direct contact with the second electrode layer E2. In the electrode portion 5b, the third electrode layer E3 is not in direct contact with the first electrode layer E1. The third and fourth electrode layers E3 and E4 of the electrode portion 5b are positioned on the main surface 3b.

The second electrode layer E2 of the electrode portion 5c covers another partial region of the first electrode layer E1 and another partial region of the side surface 3c. In the electrode portion 5c, the second electrode layer E2 is in direct contact with the other partial region of the first electrode layer E1 and the other partial region of the side surface 3c. The second electrode layer E2 of the electrode portion 5c is formed to cover the other partial region of the first electrode layer E1 of the electrode portion 5c. The other partial region of the side surface 3c is, for example, a corner region of the side surface 3c that is positioned closer to the main surface 3b and the end surface 3e. In the electrode portion 5c, the second electrode layer E2 indirectly covers a part of the ridge portion 3i such that the first electrode layer E1 is positioned between the second electrode layer E2 and the ridge portion 3i. The first electrode layer E1 of the electrode portion 5c is covered with the second electrode layer E2 at the partial region and the other partial region thereof. The first electrode layer E1 of the electrode portion 5c is exposed from the second electrode layer E2 at the remaining portion excluding the partial region and the other partial region that are covered with the second electrode layer E2.

The second electrode layer E2 of the electrode portion 5e covers another partial region of the first electrode layer E1. In the electrode portion 5e, the second electrode layer E2 is in direct contact with the other partial region of the first electrode layer E1. The second electrode layer E2 of the electrode portion 5e is formed to cover the other partial region of the first electrode layer E1 of the electrode portion 5e. In the electrode portion 5e, the second electrode layer E2 indirectly covers the region 3e_{b} of the end surface 3e such that the first electrode layer E1 is positioned between the second electrode layer E2 and the end surface 3e. The first electrode layer E1 of the electrode portion 5e is covered with the second electrode layer E2 at the partial region and the other partial region thereof. The first electrode layer E1 of the electrode portion 5e is exposed from the second electrode layer E2 at the remaining portion excluding the partial region and the other partial region that are covered with the second electrode layer E2. The second electrode layer E2 of the electrode portion 5e includes, for example, an other end-surface-side portion covering the region 3e_{b} of the end surface 3e.

In the multilayer capacitor C1₃, the second electrode layer E2 continuously covers only a part of the main surface 3a, only a part of the end surface 3e, and only a part of each of the pair of side surfaces 3c, and continuously covers only another part of the main surface 3b, only another part of the end surface 3e, and only another part of each of the pair of side surfaces 3c. The second electrode layer E2 includes a first portion continuously covering only a part of the main surface 3a, only a part of the end surface 3e, and only a part of each of the pair of side surfaces 3c, and a second portion continuously covering only another part of the main surface 3b, only another part of the end surface 3e, and only another part of each of the pair of side surfaces 3c. The above-described another part of the end surface 3e includes the region 3e_{b}. The second electrode layer E2 covers the entire ridge portion 3g, only a part of the ridge portion 3i, and only a part of the ridge portion 3j, and covers the entire ridge portion 3h, only another part of the ridge portion 3i, and only another part of the ridge portion 3j.

In the electrode portion 5e, the first electrode layer E1, the second electrode layer E2, the third electrode layer E3, and the fourth electrode layer E4 have the following configurations.

The first electrode layer E1 covers the regions 3eₐ, 3e_{b}, and 3e_{c} of the end surface 3e. The first electrode layer E1 includes a portion covering the region 3eₐ, a portion covering the region 3e_{b}, and a portion covering the region 3e_{c}. The portion covering the region 3e_{c} is closer to the main surface 3b than the portion covering the region 3eₐ. The portion covering the region 3e_{c} is closer to the main surface 3a than the portion covering the region 3e_{b}. The portion covering the region 3e_{c} is positioned between the portion covering the region 3eₐ and the portion covering the region 3e_{b} in the direction D1. In the first electrode layer E1, for example, the portion covering the region 3eₐ may include a first portion, the portion covering the region 3e_{b} may include a third portion, and the portion covering the region 3e_{c} may include a second portion and a fourth portion. In the multilayer capacitor C1₃, the second portion and the fourth portion included in the portion covering the region 3e_{c} are continuous with each other. The first electrode layer E1 is connected to the internal electrode 7 at both the portion covering the region 3eₐ and the portion covering the region 3e_{b}. The portion of the first electrode layer E1 covering the region 3e_{b} is directly connected to the connection portion 7c. The portion covering the region 3e_{b} is electrically connected to the main electrode portion 7a via the connection portion 7c.

The second electrode layer E2 is positioned on the end surface 3e to cover the portion covering the region 3eₐ and the portion covering the region 3e_{b} that are included in the first electrode layer E1 and to expose the portion covering the region 3e_{c} included in the first electrode layer E1.

The third and fourth electrode layers E3 and E4 cover the portion covering the region 3e_{c} included in the first electrode layer E1 and cover the second electrode layer E2.

In the multilayer capacitor C1₃, the connection portion 7c of the internal electrode 7 is exposed at the region 3e_{b} of the end surface 3e. The region 3e_{b} is covered with the first electrode layer E1, and the first electrode layer E1 and the connection portion 7c of the internal electrode 7 are connected to each other.

The external electrode 5 includes the second electrode layer E2. The second electrode layer E2 is included in the electrode portion 5e. The second electrode layer E2 included in the electrode portion 5e is positioned on the end surface 3e to cover the portion, of the first electrode layer E1, that covers the region 3e_{b}. The resin included in the second electrode layer E2 of the electrode portion 5e impedes hydrogen from migrating from the plating layer (for example, the third electrode layer E3) toward the portion, of the first electrode layer E1, that covers the region 3e_{b}. Therefore, hydrogen tends not to migrate to the portion, of the first electrode layer E1, that covers the region 3e_{b} and not to reach the internal electrode 7. Consequently, the multilayer capacitor C1₃ suppresses the deterioration of characteristics. For example, multilayer capacitor C1₃ suppresses a decrease in insulation resistance.

In the multilayer capacitor C1₃, the second electrode layer E2 included in the electrode portion 5e is positioned on the end surface 3e to cover the portion, of the first electrode layer E1, that covers the region 3e_{b}. Therefore, the second electrode layer E2 is positioned on an infiltration path of the plating solution to the exposed end of the internal electrode 7, i.e., the other end of the connection portion 7c. The second electrode layer E2 impedes the plating solution from infiltrating into the element body 3. Consequently, the multilayer capacitor C1₃ suppresses the deterioration of characteristics.

The plating layer covers the portion of the first electrode layer E1 that covers the region 3e_{c}. The portion of the first electrode layer E1 that covers the region 3e_{c} is connected to the plating layer without the second electrode layer E2 being interposed. Therefore, in the multilayer capacitor C1₃, the external electrode 5 includes an electric current path not including the second electrode layer E2. Consequently, the multilayer capacitor C1₃ suppresses an increase in the ESR.

The multilayer capacitor C1₃ can be mounted on the electronic device with either the main surface 3a or the main surface 3b being arranged to constitute the mounting surface. Therefore, the multilayer capacitor C1₃ does not have any orientation restrictions during mounting, and improves workability of mounting.

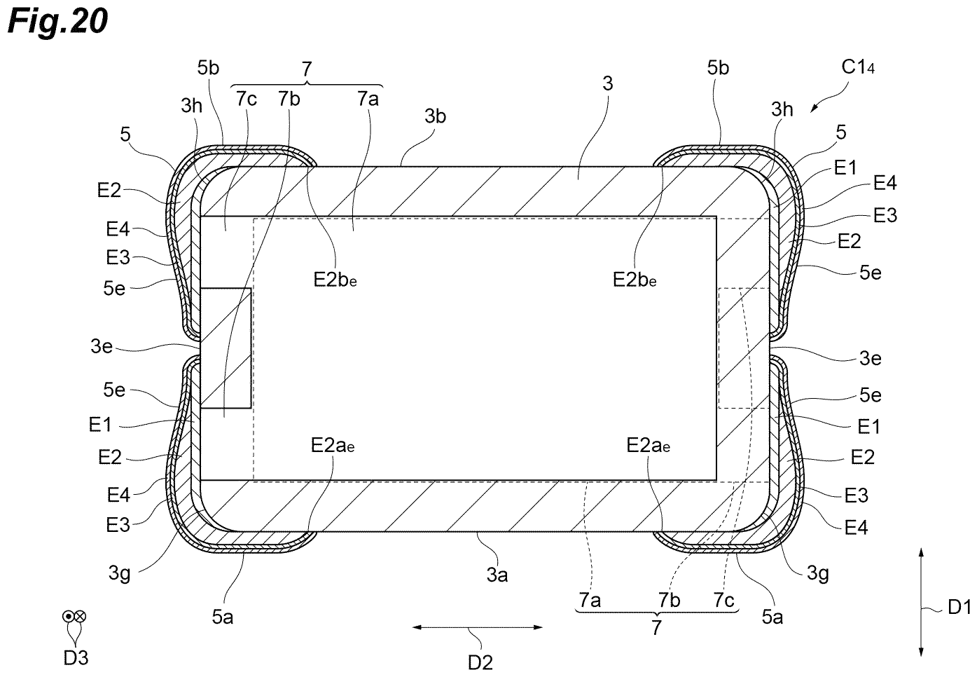

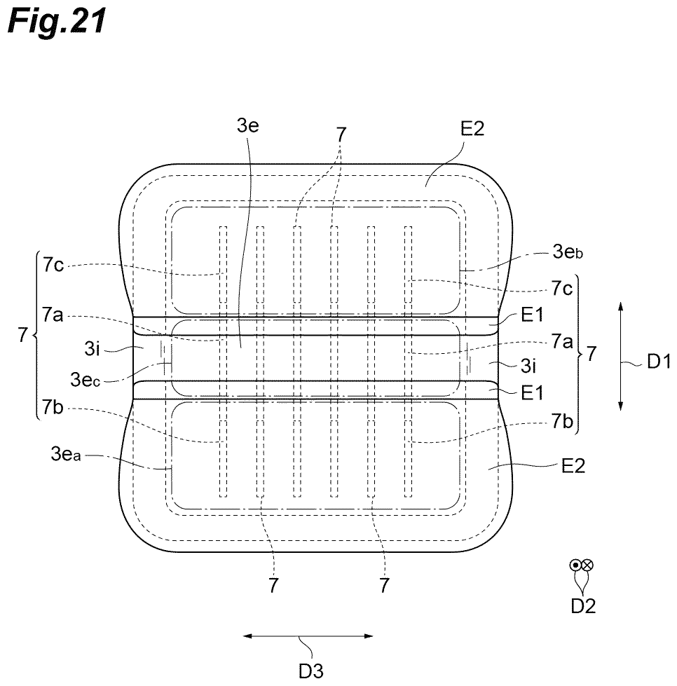

A configuration of a multilayer capacitor C1₄ according to a modification of the other example will be described with reference to FIGS. 20 and 21. FIG. 20 is a view illustrating a cross-sectional configuration of a multilayer capacitor according to a modification of the other example. FIG. 21 is a view illustrating a configuration of a second electrode layer. The multilayer capacitor C1₄ is generally similar to or the same as the multilayer capacitor C1₃ described above. However, the multilayer capacitor C1₄ is different from the multilayer capacitor C1₃ in a configuration of the external electrode 5. Hereinafter, differences between the multilayer capacitor C1₄ and the multilayer capacitor C1₃ will be mainly described. In FIG. 20, for the sake of explanation, the internal electrodes 7 adjacent each other are intentionally illustrated so as to deviate from each other in the first and second directions D1 and D2.

An electronic component includes, for example, the multilayer capacitor C1₄.

The external electrode 5 is divided into two portions, i.e., a portion positioned closer to the main surface 3a and a portion positioned closer to the main surface 3b. The portion positioned closer to the main surface 3a and the portion positioned closer to the main surface 3b are separated from each other in the direction D1. The element body 3 is exposed from the external electrode 5 between the portion positioned closer to the main surface 3a and the portion positioned closer to the main surface 3b.

The portion covering the region 3e_{c} is divided into two portions, i.e., a portion continuous to the portion covering the region 3eₐ and a portion continuous to the portion covering the region 3e_{b}. The portion continuous to the portion covering the region 3eₐ and the portion continuous to the portion covering the region 3e_{b} are separated from each other in the direction D1. The end surface 3e is exposed from the external electrode 5 between the portion continuous to the portion covering the region 3eₐ and the portion continuous to the portion covering the region 3e_{b}. The end surface 3e includes a region exposed from the external electrode 5.

In the present specification, when an element is described as being disposed on another element, the element may be directly disposed on the other element or be indirectly disposed on the other element. When an element is indirectly disposed on another element, an intervening element is present between the element and the other element. When an element is directly disposed on another element, no intervening element is present between the element and the other element.

In the present specification, when an element is described as being positioned on another element, the element may be directly positioned on the other element or be indirectly positioned on the other element. When an element is indirectly positioned on another element, an intervening element is present between the element and the other element. When an element is directly positioned on another element, no intervening element is present between the element and the other element.

In the present specification, when an element is described as covering another element, the element may directly cover the other element or indirectly cover the other element. When an element indirectly covers another element, an intervening element is present between the element and the other element. When an element directly covers another element, no intervening element is present between the element and the other element.

It is to be understood that not all aspects, advantages and features described herein may necessarily be achieved by, or included in, any one particular example. Indeed, having described and illustrated various examples herein, it should be apparent that other examples may be modified in arrangement and detail.

In each of the multilayer capacitors C1₃ and C1₄, the main electrode portion 7a may be shaped such that a corner closer to the main surface 3a on the other end side and a corner closer to the main surface 3b on the other end side are cut out. In this case, each of the multilayer capacitors C1₃ and C1₄ suppresses the occurrence of migration similarly to the multilayer capacitor C1₁.

Each of the multilayer capacitors C1₃ and C1₄ may include a plurality of conductors 11. In this case, each of the multilayer capacitors C1₃ and C1₄ suppresses the occurrence of migration similarly to the multilayer capacitor C1₂.

In the present examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body of a rectangular parallelepiped shape including a first main surface and a second main surface opposing each other in a first direction, a pair of end surfaces opposing each other in a second direction, and a pair of side surface opposing each other in a third direction;
a plurality of external electrodes disposed on both ends of the element body in the second direction and each including a sintered metal layer, a conductive resin layer, and a plating layer; and
a plurality of internal electrodes disposed in the element body to oppose each other in the third direction and each electrically connected to a corresponding external electrode of the plurality of external electrodes,
wherein each of the plurality of internal electrodes includes:
a main electrode portion opposing an internal electrode, of the plurality of internal electrodes, that is adjacent in the third direction; and
a connection portion narrower than the main electrode portion in the first direction and connecting the main electrode portion and the corresponding external electrode, the connection portion being exposed at a partial region, of the end surface, that is positioned closer to the first main surface,
the sintered metal layer includes:
a first portion covering the partial region of the end surface and connected to the connection portion; and
a second portion covering at least a partial region, of the end surface, that is positioned closer to the second main surface than the partial region,
the conductive resin layer includes one end-surface-side portion positioned on the end surface to cover the first portion and expose the second portion, and
the plating layer covers the second portion and the one end-surface-side portion.

2. The electronic component according to claim 1, wherein
the sintered metal layer entirely covers the end surface.

3. The electronic component according to claim 1, wherein
each of the plurality of internal electrodes includes an other connection portion narrower than the main electrode portion in the first direction and connecting the main electrode portion and the corresponding external electrode, the other connection portion being exposed at an other partial region, of the end surface, that is positioned closer to the second main surface,
the sintered metal layer includes:
a third portion covering the other partial region of the end surface and connected to the other connection portion; and
a fourth portion covering at least a partial region, of the end surface, that is positioned closer to the first main surface than the other partial region,
the conductive resin layer includes an other end-surface-side portion positioned on the end surface to cover the third portion and expose the fourth portion, and
the plating layer covers the fourth portion and the other end-surface-side portion.

4. The electronic component according to claim 3, wherein
the second portion and the fourth portion are continuous with each other, and
the end surface is entirely covered with the external electrode.

5. The electronic component according to claim 3, wherein
the second portion and the fourth portion are separated from each other, and
the end surface is exposed from the external electrode between the second portion and the fourth portion.

6. The electronic component according to claim 1, wherein
the conductive resin layer includes a first-main-surface-side portion continuous to the one end-surface-side portion and covering a part of the first main surface,
the main electrode portion includes:
a first edge opposing, in the first direction, a region of the first main surface covered with the first-main-surface-side portion; and
a second edge opposing, in the first direction, a region of the first main surface exposed from the conductive resin layer,
the first edge includes an edge region in which a distance between the edge region and the first main surface in the first direction is larger than a distance between the second edge and the first main surface in the first direction.

7. The electronic component according to claim 6, wherein
the first edge includes only the edge region.

8. The electronic component according to claim 1, further comprising a dummy conductor disposed in the element body, wherein
the conductive resin layer includes a side-surface-side portion continuous with the one end-surface-side portion and covering a part of the side surface, and
the dummy conductor is adjacent to the side-surface-side portion in the third direction, and is electrically connected to the side-surface-side portion.

9. The electronic component according to claim 8, wherein
with a plane including the first main surface as a reference plane, a length in the first direction from the reference plane to an edge of the dummy conductor opposing the second main surface is larger than a length of the side-surface-side portion from the reference plane in the first direction.

10. The electronic component according to claim 1, wherein
the conductive resin layer includes a side-surface-side portion continuous with the one end-surface-side portion and covering a part of the side surface, and
the side-surface-side portion and an internal electrode, of the plurality of internal electrodes, that is not electrically connected to the side-surface-side portion do not overlap each other, when the side-surface-side portion and the internal electrode not electrically connected to the side-surface-side portion are viewed from the third direction.
